(19) United States
(12) Patent Application Publication
(10) Pub. No.: US 2026/0340527 A1
(43) Pub. Date: Oct. 29, 2026

(54) MULTI-ALGORITHM SIGNAL PROCESSING OF RESOURCE CONSUMPTION

(71) Applicant: Live Nation Entertainment, Inc., Beverly Hills, CA (US)

(72) Inventor: Mohammad-Khosrow Mohebi, Quebec (CA)

(73) Assignee: Live Nation Entertainment, Inc., Beverly Hills, CA (US)

(21) Appl. No.: 19/658,333

(22) Filed: Apr. 24, 2026

Related U.S. Application Data
(60) Provisional application No. 63/795,160, filed on Apr. 25, 2025.

(51) Int. Cl. G06Q 10/0631

(52) U.S. Cl. CPC G06Q 10/0631

(57) ABSTRACT

A signal processing system to analyze multiple peak signals related to an event receives event-related signal data and, via a velocity rule engine, calculates a first exponential moving average (EMA) over a first time interval and a second EMA over a second time interval. The velocity rule engine further determines a first weight and calculates a first approximation of a derivative of the signal data and a second approximation of the derivative of the first approximation. The velocity rule engine determines a second weight and identifies different triggers. The signal processing system further applies a statistical algorithm to analyze a graphical distribution, determines a third weight, and calculates a coefficient value. The signal processing system generates multiple resource rates based on the coefficient value, generates an alert, and modifies the resource rates based on feedback.

### PRIORITY

This application is a non-provisional of and claims priority to U.S. Provisional Application No. 63/795,160, filed on Apr. 25, 2025, which is incorporated herein by reference for all purposes.

### BACKGROUND

This disclosure relates, in general, to resource management, and by way of example, to recommending resource rates for resources associated with an event, among other applications.

An event management system maintains metadata, such as performer data, event topology, timestamps, and geo-policy constraints, and represents primary allocations of the resources along with states (e.g., available, reserved, and transferred). The resource rates are layered atop the primary allocations and can be defined at multiple granularities, for example, a global level, a zonal level, and/or a micro-zonal level. Resource agents and/or primary operators of an entity interact with a resource console to set and resolve effective rates, while listing resource values, states, and assessments.

The formation of primary resource rates relies on multiple factors, for example, traffic pattern, context signals, ranking, venue constraints, and event locations. Guardrails (e.g., floors/ceilings, max % change per window, and fairness policies) further guarantee resource protection and regulatory compliance. Limited visibility into real-time trends and a lack of trend awareness result in stale primary resource rates. Secondary resource agents and secondary operators are equipped with alerting systems that detect a real-time gap and initiate low-value transactions from the primary operators. The secondary operators elevate the resource rates and capture a consumer surplus that would otherwise accumulate to the primary operators and the entity. An inability of the primary operators to adapt to the real-time trends leads to rate drift at suboptimal margins. Root causes include a latency in signal ingestion, insufficient feature coverage, weak feedback loops, and delayed approval bottlenecks.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specifications of this disclosure, any or all drawings and each claim.

In one embodiment, a signal processing system to analyze multiple peak signals related to an event receives event-related signal data and, via a velocity rule engine, calculates a first exponential moving average (EMA) over a first time interval and a second EMA over a second time interval. The velocity rule engine further determines a first weight and calculates a first approximation of a derivative of the signal data and a second approximation of the derivative of the first approximation. The velocity rule engine determines a second weight and identifies different triggers. The signal processing system further applies a statistical algorithm to analyze a graphical distribution, determines a third weight, and calculates a coefficient value. The signal processing system generates multiple resource rates based on the coefficient value, generates an alert, and modifies the resource rates based on feedback.

In an embodiment, a signal processing method for analyzing multiple peak signals related to an event is disclosed. In one step, the signal processing method includes receiving signal data associated with the event from a resource allocation service and calculating, via a velocity rule engine, a first exponential moving average (EMA) of the signal data over a first time interval and a second EMA of the signal data over a second time interval. The velocity rule engine further determines a first weight based on a normalized difference between the first EMA and the second EMA. The velocity rule engine calculates a first approximation of a derivative of the signal data over a sampling period and a second approximation of the derivative of the first approximation with respect to the sampling period. The first approximation of the derivative of the signal data indicates a velocity and the second approximation of the derivative of the first approximation indicates an acceleration. The velocity rule engine calculates the velocity based on a central difference of the signal data over twice the sampling period and determines a second weight associated with the second approximation. In another step, the signal processing method includes setting a first threshold for the second approximation to identify triggers from an acceleration trend. The velocity rule engine combines the first EMA, the second EMA, and the second approximation to identify the triggers. The signal processing method further includes applying a statistical algorithm to analyze a graphical distribution generated from the first EMA, the second EMA, and the second approximation, and determining a third weight based on the graphical distribution. The graphical distribution is a Poisson distribution in one embodiment. The signal processing method further includes calculating a probability of resource transfers and setting a second threshold based on the probability of the resource transfers to detect multiple outliers in the graphical distribution. The signal processing method includes calculating a coefficient value based on the first weight, the second weight, and the third weight, and generating multiple resource rates based on the coefficient value. The signal processing method includes generating resource rates based on a recent resource rate of a resource associated with the event and different seat quality indices (SQIs) of an event location. The signal processing method includes generating an alert based on the multiple resource rates and/or different triggers and modifying the resource rates based on feedback on the resource rates. The signal processing method further includes analyzing the feedback using an artificial intelligence (AI) module. The feedback includes an approval, a disapproval, or an update of the resource rates.

In another embodiment, a signal processing system to analyze multiple peak signals related to an event is disclosed. The signal processing system receives signal data associated with the event from a resource allocation service and calculates, via a velocity rule engine, a first exponential moving average (EMA) of the signal data over a first time interval and a second EMA of the signal data over a second time interval. The velocity rule engine further determines a first weight based on a normalized difference between the first EMA and the second EMA. The velocity rule engine calculates a first approximation of a derivative of the signal data over a sampling period and a second approximation of the derivative of the first approximation with respect to the sampling period. The first approximation of the derivative of the signal data indicates a velocity and the second approximation of the derivative of the first approximation indicates an acceleration. The velocity rule engine calculates the velocity based on a central difference of the signal data over twice the sampling period and determines a second weight associated with the second approximation. The signal processing system sets a first threshold for the second approximation to identify different peak signals from an acceleration trend. The velocity rule module combines the first EMA, the second EMA, and the second approximation to identify different triggers. The signal processing system further applies a statistical algorithm to analyze a graphical distribution generated from the first EMA, the second EMA, and the second approximation, and determines a third weight based on the graphical distribution. The graphical distribution is a Poisson distribution in one embodiment. The signal processing system computes a probability of resource transfers and sets a second threshold based on the probability of the resource transfers to detect outliers in the graphical distribution. The signal processing system calculates a coefficient value based on the first weight, the second weight, and the third weight, and generates multiple resource rates based on the coefficient value. The signal processing system generates an alert based on the multiple resource rates and/or different triggers and modifies the resource rates based on feedback on the resource rates. The signal processing system further analyzes the feedback using an artificial intelligence (AI) module. The feedback includes an approval, a disapproval, or an update of the resource rates.

In yet another embodiment, a computer-readable medium having computer-executable instructions embodied thereon that, when executed by one or more processors, facilitates a signal processing method for analyzing a plurality of peak signals related to an event. In one step, the signal processing method includes receiving signal data associated with the event from a resource allocation service and calculating, via a velocity rule engine, a first exponential moving average (EMA) of the signal data over a first time interval and a second EMA of the signal data over a second time interval. The velocity rule engine further determines a first weight based on a normalized difference between the first EMA and the second EMA. The velocity rule engine calculates a first approximation of a derivative of the signal data over a sampling period and a second approximation of the derivative of the first approximation with respect to the sampling period. The first approximation of the derivative of the signal data indicates a velocity and the second approximation of the derivative of the first approximation indicates an acceleration. The velocity rule engine calculates the velocity based on a central difference of the signal data over twice the sampling period and determines a second weight associated with the second approximation. In another step, the signal processing method includes setting a first threshold for the second approximation to identify triggers from an acceleration trend. The velocity rule engine combines the first EMA, the second EMA, and the second approximation to identify the triggers. The signal processing method further includes applying a statistical algorithm to analyze a graphical distribution generated from the first EMA, the second EMA, and the second approximation, and determining a third weight based on the graphical distribution. The graphical distribution is Poisson distribution in one embodiment. The signal processing method includes computing a probability of resource transfers and setting a second threshold based on the probability of the resource transfers to detect outliers in the graphical distribution. The signal processing method includes calculating a coefficient value based on the first weight, the second weight, and the third weight, and generating multiple resource rates based on the coefficient value. The signal processing method further includes generating resource rates based on a recent resource rate of the resource associated with the event and different seat quality indices (SQIs) of an event location. The signal processing method includes generating an alert based on the resource rates and/or different triggers and modifying the resource rates based on feedback on the resource rates. The signal processing method further includes analyzing the feedback using an artificial intelligence (AI) module. The feedback includes an approval, a disapproval, or an update of the resource rates.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of a resource management system;

FIG. 2 illustrates hardware and network connections of the resource management system;

FIG. 3 illustrates an event management system that incorporates a signal processing system to analyze different peak signals;

FIG. 4 illustrates a block diagram of communication of a user device with an application interface;

FIG. 5 illustrates a block diagram of an event location manager;

FIG. 6 illustrates the signal processing system that analyzes different peak signals via a velocity rule engine;

FIG. 7 illustrates a flow of a signal processing method performing multiple algorithms on the signal data;

FIG. 8 illustrates a graphical user interface (GUI) depicting different configurations for event data;

FIGS. 9A-9D illustrate different exemplary embodiments of resource transfers trends;

FIGS. 10A-10B illustrate exemplary embodiments of the EMAs calculated on signal data;

FIG. 11A illustrates a count graph of a resource transfer count within a period;

FIG. 11B illustrates a velocity graph of a transfer velocity between adjacent intervals;

FIG. 12A illustrates an acceleration graph of a second approximation of a derivative of a first approximation shown in the velocity graph;

FIG. 12B illustrates a rule graph of the resource transfer count with triggered points identified by a second algorithm;

FIGS. 13A-13B illustrate statistical techniques to analyze the signal data;

FIG. 14A illustrates a data curve;

FIG. 14B illustrates a statistical curve of applying statistical operations on the signal data;

FIG. 14C illustrates an approximation curve of derivatives of the signal data;

FIG. 14D illustrates a distribution curve;

FIG. 15 illustrates a signal processing method for analyzing multiple peak signals related to the event; and

FIG. 16 illustrates a flowchart of training an artificial intelligence (AI) module based on weights.

In the appended figures, similar components and/or features may have the same reference label. When the same reference label is used in the specification or drawings, the description is applicable to any one of the similar components.

### DETAILED DESCRIPTION OF THE DRAWINGS

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

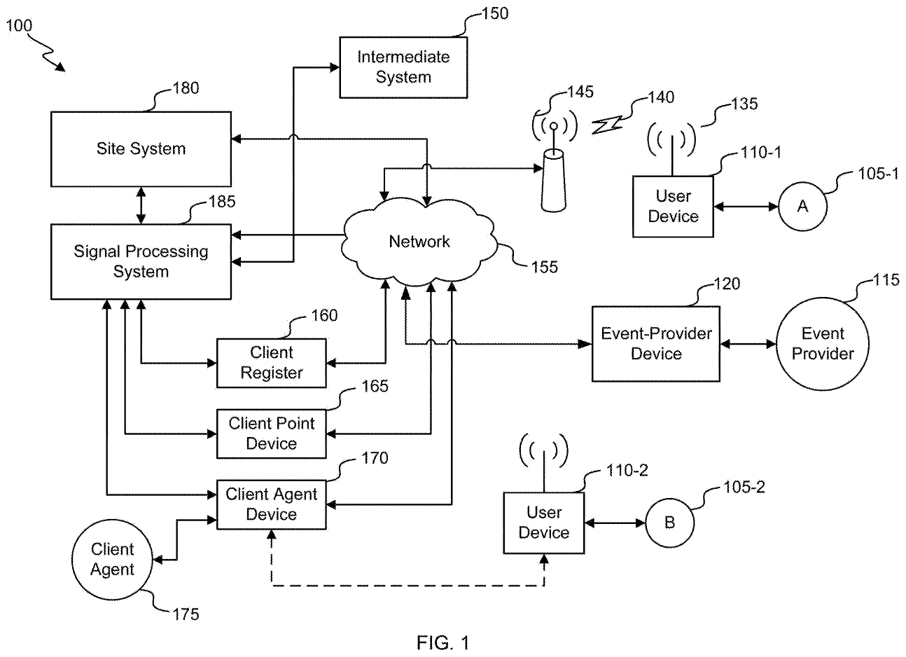

Referring to FIG. 1, a block diagram of a resource management system 100 is shown as an embodiment. The resource management system 100 includes a user 105-1 and 105-2, collectively referred to as users 105, a user device 110-1, 110-2, an event provider 115, an event-provider device 120, an antenna 135, a communication channel 140, and an access point 145. The resource management system 100 further includes an intermediate system 150, a network 155, a client register 160, a client point device 165, a client agent device 170, a client agent 175, a site system 180, and a signal processing system 185. The terms “user” and “user(s)” are used interchangeably throughout this disclosure. Similarly, the terms “user device” and “user device(s)” are used interchangeably throughout this disclosure.

The users 105-1, and 105-2 operate the user devices 110-1, and 110-2. The event provider 115 operates/controls, and uses the event-provider device 120. The user device 110-1, 110-2, and the event-provider device 120 communicate with the signal processing system 185 directly or via the intermediate system 150. The user devices 110-1, 110-2 use a wireless connection, such as the communication channel 140, to communicate with the access point 145. The user devices 110-1, 110-2 transmit data to the access point 145 connected to the network 155. The user devices 110-1, 110-2 use the antenna 135 to transmit the data over the communication channel 140. In another embodiment, the user devices 110-1, 110-2 use a wired connection, such as an Ethernet connection, to communicate with the access point 145. The user devices 110-1, 110-2 further use the wired connection or the wireless connection to communicate with client devices, such as the client agent device 170 operated by the client agent 175, the client register 160, and the client point device 165. The event provider 115 provides the signal processing system 185 with information about an event, timestamps of the event, and an event location. Examples of the event location include, but are not limited to, a stadium, a concert hall, or a theater. The components of the resource management system 100 communicate through the network 155 and facilitate the transmission of different types of data.

The resource management system 100 manages access rights for connection in a queue. The signal processing system 185 analyzes peak signals within a time window based on event traffic and traffic context, and generates alerts based on updates to resource rates of the resources. The signal processing system 185 permits the users 105-1, 105-2 to connect to the queue upon successful resource transaction. In one embodiment, the signal processing system 185 also allocates access rights of the resources and facilitates transmission of notifications and alerts related to the resources and associated resource rates available to the users 105-1, 105-2. For example, the signal processing system 185 notifies the users 105-1, 105-2 about updated resource rates and availability of the resources via a website, an app page, or an email. As another example, the signal processing system 185 transmits data related to the access rights and the resources to the intermediate system 150, facilitating the processing of requests related to the access rights.

The signal processing system 185 provides a multi-algorithm signal processing of the resource consumption data related to the event. The signal processing system 185 analyzes the peak signals occurring due to a load spike and variable trends, updates the resource rates, and generates the alerts to the users 105-1, 105-2, to the client agent 175, and/or to primary operators. The signal processing system 185 modifies the status of the resources and generates access-enabling codes at the user device 110-1 to notify that the user 105-1 is allowed to enter the queue after accepting the updated resource rates. The resources are partly controlled by the client agent 175 and/or the primary operators. In an embodiment, the primary operators control the resources via an operator terminal (not shown). For example, the primary operators review the resource rates, allocation positions, and readiness of the resources related to the event. From hereinafter, the terms “primary operator” and “operator” are used interchangeably.

The resource is managed and provided by a primary operator, such as a performer and/or the entity managing the event location. In an embodiment, the primary operator regulates a relatively small subset of the allocation positions (e.g., 200 out of 18,000 seats) and therefore, the resource rates for a subset of the allocation positions. In other embodiments, the primary operator regulates the allocation positions along with associated resources at a global level of the event location, at a zonal level of the event location, or at a micro-zonal level of the event location. In cases where the operators are unaware of real-time trends, secondary operators elevate the resource rates and capture a consumer surplus that would otherwise accumulate to the primary operators and the entity.

The resources are used at the event location, where client devices are also present to facilitate their usage. The client agent 175 operates the client agent device 170. The client register 160 operates without an agent and connects to a device that impedes resource access in a locked mode, such as a turnstile. The client point device 165 operates without the agent and is positioned at the event location. The client register 160 is connected to a turnstile, a gate, or a lockable door, positioned in proximity to the event location. The client point device 165 may be an electronic device positioned at the event location.

The users 105-1, 105-2 access the user devices 110-1, 110-2 to perform different operations. For example, the user 105-1 accesses the user device 110-1 to request the access rights, while the user 105-2 accesses the same device to interact with client devices. In an embodiment, the user devices 110-1, 110-2, the intermediate system 150, the client agent device 170, the client register 160, and the client point device 165 include a portable electronic device or a non-portable electronic device. Examples of the portable electronic device include, but are not limited to, a smart phone, tablet, laptop computer, and smart wearable device. Examples of the non-portable electronic device include, but are not limited to, a desktop computer, server, and processor.

The data maintained at the signal processing system 185 includes the data related to the access rights, seat quality indices (SQIs), the resource rates, a recent resource rate, and updated resource rates. For example, a database or a data store includes a list of identifiers of the users 105-1, 105-2 or the user devices 110-1, 110-2 having an assigned access right for the event location. The signal processing system 185 communicates with the intermediate system 150. The intermediate system 150 is controlled by another entity different than the entity executing the signal processing system 185. For example, the signal processing system 185 assigns the access rights to the intermediate system 150 upon acceptance of terms and the resource rates. The intermediate system 150 collects the data pertaining to the assigned access rights or the event, formats and edits the data, and generates a notification upon availability of the access rights. The notification includes the formatted and edited data, and the intermediate system 150 facilitates presentation of the notification at the user devices 110-1, 110-2.

When the intermediate system 150 receives a communication from the user devices 110-1, 110-2 indicating an access-right request, the intermediate system 150 facilitates an assignment or a reassignment of the access right to the users 105-1, 105-2, based on acknowledging the resource rates. The intermediate system 150 transmits the relevant information to the signal processing system 185, identifies the users 105-1, 105-2 or the user devices 110-1, 110-2, or transmits the relevant information pertaining to the access rights to the user devices 110-1, 110-2 to facilitate the assignment or reassignment of the access rights.

The user devices 110-1, 110-2 transmit the data corresponding to the access right of entering the queue, such as the access-enabling code, to the client device upon detecting the client device. The client device receiving the access-enabling code includes the client agent device 170 operating at an ingress point of the event location and the client register 160 attached to a locking turnstile. The client device analyzes the access-enabling code to confirm the validity of the resource and manages admittance of the user 105-1, 105-2 to the event based on the validation result. For example, the locking turnstile changes from the locked mode to an unlocked mode upon validation of the access-enabling code.

In an embodiment, the resource management system 100 executes a resource allocation service. The resource allocation service keeps records of resource transactions, history of resource requests within the time window, and number of reserved and/or transferred resources during the time window as signal data. The resource allocation service connects to the signal processing system 185 via the network 155 and transmits the signal data to the signal processing system 185 to analyze the signal data and the peak signals. The network 155 includes an open network, such as an internet, a personal area network, a Local Area Network (LAN), a Campus Area Network (CAN), a Metropolitan Area Network (MAN), a Wide Area Network (WAN), a Wireless Local Area Network (WLAN). In another embodiment, the network 155 includes a private network, such as an intranet and extranet. In yet another embodiment, the network 155 includes a short-range communication channel, such as Bluetooth or Bluetooth Low Energy (BLE). The short-range communication channel provides reduced power consumption and enables proximity level detection and communication across moderate distances. The resource management system 100 achieves high-level security through encryption and short-range communication, eliminating the need for pairing in inter-device communications.

The resource management system 100 uses a secure communications protocol, such as a secure sockets layer (SSL) or a transport layer security (TLS), to achieve communication between its components or devices. The resource management system 100 encrypts the data and transactional details based on a developed method, such as a data encryption standard (DES), Blowfish, advanced encryption standard (AES), and Tiny Encryption Algorithm (TEA). Some components or devices of the resource management system 100 are combined. For example, the client agent device 170 may also serve as the intermediate system 150 to facilitate the assignment of the access rights.

The interaction between the user device 110-1 and the client device verifies that the user 105-1 have a valid and applicable access right. The interaction between the user devices 110-1, 110-2, and the client device enables the resource management system 100 to obtain the assignment of the access rights and an upgraded access right due to an updated resource rate. The user devices 110-1, 110-2 directly interacts with the client device located at the event location during the event. For example, the user device 110-2 communicates with the client agent device 170 over the short-range communication channel. When the communication channel 140 is established, the user device 110-2 communicates with the intermediate system 150 to gain access rights to the resource. The user devices 110-1, 110-2 communicate over the network 155, but the user devices 110-1, 110-2 may also communicate with the signal processing system 185 via the client agent device 170, instead of the network 155. In an embodiment, the components of the resource management system 100 are geographically separate. In another embodiment, two identical components of the resource management system 100 are geographically separate. For example, two different site systems may be located at different geographic locations.

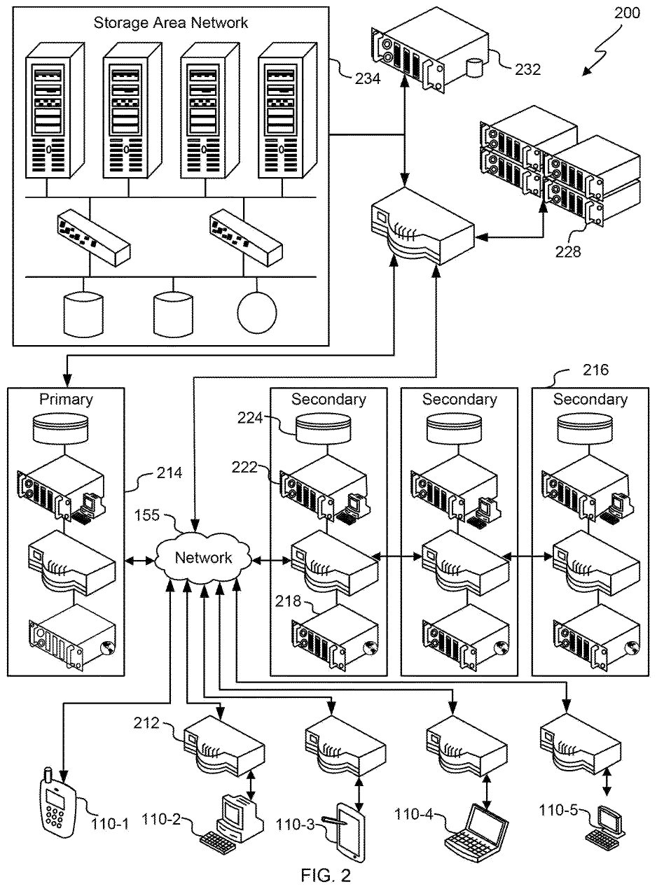

Referring next to FIG. 2, hardware and network connections 200 of the resource management system 100 are shown as an embodiment. The resource management system 100 facilitates an organization of the resources, access rights, and resource reservations. The hardware and network connections 200 include a router 212, a primary assignment management system 214, a secondary assignment management system(s) 216, a data management server farm 228, a network-attached storage 232, and a storage-area network 234. The primary assignment management system 214 and the secondary assignment management system(s) 216 include a web server 218, a management server 222, and a data store 224. The user devices 110 connect to the primary assignment management system 214 or the secondary assignment management system(s) 216 via inter-network connection components, such as the router 212 and the network 155. The terms “secondary assignment management system” and “secondary assignment management system(s)” are used interchangeably throughout this disclosure.

The primary assignment management system 214 coordinates and controls an initial assignment of the access rights. The secondary assignment management system 216 coordinates and controls the reassignment and a transfer of the access rights. The access rights are transferred between the users 105-1 and 105-2, or between the user devices 110-1 and 110-5, and from an intermediate agent to either the user 105-1 or the user device 110-1. The transfer of the access rights occurs as a result of a resource transaction confirming the resource rate. The secondary assignment management system 216 also manages transfer offers to detect if a valid request is received from the user 105-1. The secondary assignment management system 216 further allows a user device 110-3 to identify the resource rate. In an embodiment, although the primary assignment management system 214 is separated from the secondary assignment management system 216, an individual of the primary and secondary assignments relates to both a primary channel and a secondary channel. The data store 224 or a localized cluster of data stores includes data from both the primary channel and the secondary channel.

The primary assignment management system 214 and the secondary assignment management system 216 include a web server 218 that processes and responds to Hypertext Transfer Protocol (HTTP) requests. The web server 218 retrieves and delivers web-page data to the user device 110-1, 110-2. For example, the web server 218 identifies an allocation position, such as a seat, and standout characteristic of an individual access right. The web server 218 further includes an invitation to request the assignment of the access right and facilitates establishing or updating an account. The web server 218 supports server-side scripting and receives the data, such as forms or file uploads, from the user devices 110-1, 110-2, 110-3, 110-4, and 110-5. The web server 218 communicates the data related to the allocation position and the availability of the resources. The web server 218 receives a communication request from the user devices 110-1, 110-2, 110-3, 110-4, and 110-5 corresponding to information related to the access rights. The request includes constraints corresponding to values of individual fields, such as the values to be matched or to be defined in a range.

The management server 222 interacts with the web server 218 to provide indications regarding the availability of the resources for the assignment, characteristics of the resources, and the data assessed to assign the access rights. When requisite information about the users 105-1, 105-2 or the user devices 110-1, 110-2 is received, the resource management system 100 identifies a final request for the resources. The final request includes transaction information. The management server 222 coordinates the assignment of the resources. The coordination involves updating the data store 224 to change the status of the resources to “assigned”. The management server 222 updates the status to associate the resources with the users (105-1, 105-2), or the user devices 110-1, 110-2, generating or identifying access-enabling codes (the access rights) for these resources. This facilitates the transmission of the access rights to the user devices 110-1, 110-2, 110-3, 110-4, and 110-5. The transmission includes the access-enabling codes and reflects the assignment.

The management server 222 queries, updates, and manages the data store 224 to identify the access rights, characteristics of the access rights, and to reflect a new assignment. The data store 224 includes the data associated with the primary assignment management system 214 or the secondary assignment management system 216. In an embodiment, the data store 224 includes incomplete data related to the access rights. For example, the data store 224 includes the data about an incomplete subset of the access rights allocated for the resource. For example, if the client agent 175 indicates that an independent intermediary system exclusively or non-exclusively coordinates the assignment of some access rights, and not for the rest of the access rights. The data store 224 then selectively includes the information for those access rights.

The data store 224 associated with the primary assignment management system 214 or the secondary assignment management system 216 handles the assignment data for the access rights. For example, the data store 224 keeps the status of the access right as “available” until the primary assignment management system 214 or the secondary assignment management system 216 allocates the access right. In an embodiment, the primary assignment management system 214 and the secondary assignment management system 216 communicate to alert one another regarding resource assignments.

The management server 222 sends a communication to the data management server farm 228 to reflect recent assignments. The communication includes the identifier of the access rights, an indication of the assignment of the access rights, identifiers of the users 105-1, 105-2, or the user device 110, and the access-enabling code generated during the assignment. The management server 222 sends the communication as a precursor for the assignment of the access rights. The communication confirms availability of the access right or requests authorization of the assignment at defined times, after defined time intervals, or in response to an assignment-update request received from the data management server farm 228. The data management server farm 228 updates a central data store to reflect the data received from the communication. The data management server farm 228 further updates the central data store, incorporating the update of the resource rates based on peak signals analysis. The central data store is a part of the network-attached storage 232 or the storage-area network 234.

The data store 224 includes a cache storing the data associated with previous communications with the data management server farm 228. The data management server farm 228 periodically transmits assigned statuses of the access rights or updated statuses indicating the assignment of the access rights. An access assignment system includes the primary assignment management system 214 and the secondary assignment management system 216. The data management server farm 228 transmits the statuses upon receiving the request from the access assignment system for statuses or for authorization of the assignment.

In an embodiment, the access assignment system may not include a local or system-inclusive data store for tracking the statuses, assignments, and characteristics of the access rights. In another embodiment, the access assignment system may also communicate with a remote or central data store. The signal processing system 185 may include the primary assignment management system 214, secondary assignment management system 216, data management server farm 228, and central data store. The intermediate system 150 also includes the primary assignment management system 214 and the secondary assignment management system 216.

The data management server farm 228 periodically assesses a connection with the access assignment system. For example, a test communication indicates the request to respond. If a response communication is not received within a defined time period, or if the response does not include the requested data, or if it reflects poor data integrity, network speed, or processing speed, then the data management server farm 228 reconfigures the access rights. The data management server farm 228 reconfigures permissions or transmits another communication indicating that the access rights are limited, to prevent the assignment of the access rights.

In an embodiment, the components in the hardware and network connections 200 are geographically separate. In another embodiment, two identical components are geographically separate. For example, two secondary assignment management systems may be located at different geographic locations. In another embodiment, a load balancer signal splits processing tasks across multiple data management server farms or access assignment systems. The data management server farms 228 accepts an increased or full load when another data management server farm is unavailable. The data stored in the central data store is replicated in geographically separate data stores.

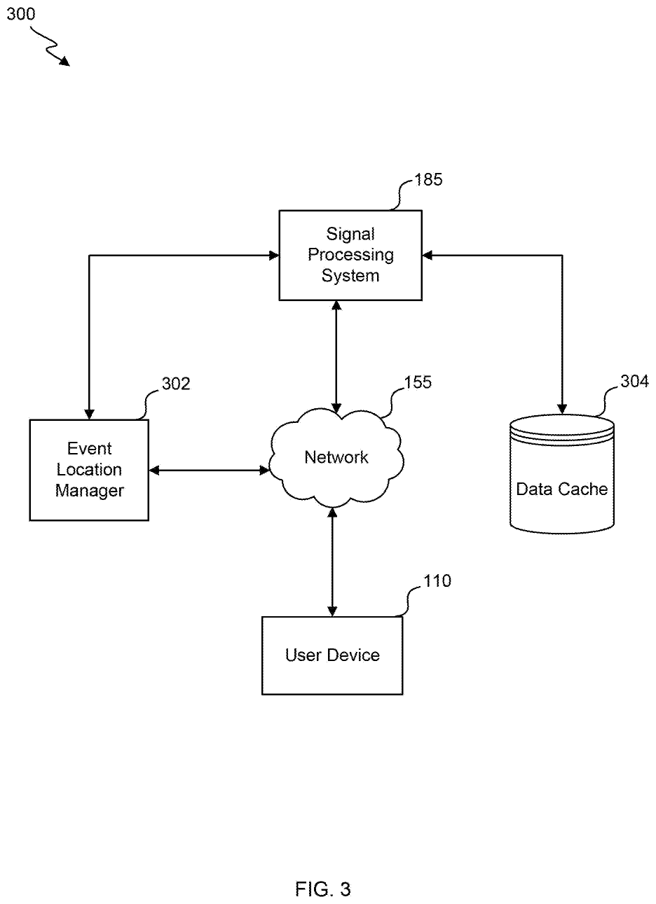

Referring next to FIG. 3, an event management system 300 that incorporates the signal processing system 185 to analyze different peak signals is shown as an embodiment. The event management system 300 broadcasts the resources set by the resource management system 100 and logs the resource rates. Furthermore, the event management system 300 invokes the resource management system 100 when a new event or an updated event needs the resources and the resource rates to be defined. The event management system 300 includes the network 155, the signal processing system 185, a user device 110, an event location manager 302, and a data cache 304.

In an embodiment, different entities that are hosting the event at the event location, invoke the event location manager 302. The event location manager 302 generates and/or transmits event-related information and entity communication. The event location manager 302 is provided with the event-related information by the primary operators, the entities, or third party/external server(s). For example, the event location manager 302 includes a series of the play Hamilton on 10 particular nights.

The entities use servers or the event location manager 302 to transmit the resources and the access rights to the user device 110 and receive the resource rates predefined by the primary operators. The user device 110 receives the resource and information of the event location from the entities via the servers (not shown) or the event location manager 302. The user device 110 further receives the information on the resource rates of the event location from the signal processing system 185. In an embodiment, the user device 110 receives the information on updated resource rates from the signal processing system 185 after the signal processing system 185 analyzes the peak signals observed in the time window. The user device 110 reserves the resources and/or gains the access rights of the resources after completing the resource transaction directly from the event location manager 302.

The user device 110 requests an assignment of resources/tokens. Examples of the user device 110 include, but are not limited to, any portable computing device, e.g., smartphones, mobile phones, tablets, and/or other similar devices. A singular user (or a fan) attending an event inside the event location can accompany the user device 110. Multiple activities can be performed with the help of the user device 110, for example, carrying the resource in digital form, presenting the resource to an application running on a scanner for user authentication, and making resource transactions inside the event location. While presenting the resource at an ingress checkpoint, the user device 110 may communicate with the scanner over the short-range communication channel, such as Bluetooth, BLE channel, Near Field Communication (NFC), Wi-Fi, Radio Frequency Identification (RFID), Zigbee, Adaptive Network Topology (ANT), etc. Examples of the scanner include, but are not limited to, a bar code scanner, a magnetic card reader, or a camera that scans the access rights of the resources at the ingress checkpoint. In an embodiment, the event management system 300 includes different user devices.

The signal processing system 185 generates signals to notify the users, the operators, and the performers about a change in event trends or resource consumption that needs consideration, notably in terms of the resource rates. The resource consumption indicates a trend of resource reservation, event demand, resource transactions, and commodities in events, etc. A signal spike in the resource transfers or an abrupt decrease in the resource transactions during the time window enables the signal processing system 185 modify the resource rates. The signal processing system 185 analyzes the trends of the resource consumption during a time span. Based on a peak signal analysis, the signal processing system 185 notifies vendors or the operators at different time instances when the resource rates are to be modified based on the resource consumption rather than the operators having several alerts on various conditions.

The trends of the resource consumption are real-time changes that are captured in the form of signals by the signal processing system 185. The signal processing system 185 uses multiple statistical algorithms to capture a peak signal in a traffic pattern and traffic context of resource transfer data. The resource transfer data may be extracted from Application Programming Interfaces (APIs), data sources, or via resource application services. The signal processing system 185 uses different algorithms to dynamically identify high and low velocity conditions in the resource transfer data and resource transaction trends to generate velocity rules based on the velocity conditions. The signal processing system 185 further sets distinct thresholds for detecting the peak signals in the resource transfer data based on the velocity conditions.

In an embodiment, the signal processing system 185 provides recommendations to the primary operators to update the resource rates associated with the resources based on the peak signal analysis and the velocity conditions. Multiple algorithms provide respective weights to change the resource rates. The signal processing techniques include Exponential Moving Averages (EMAs) and statistical methods, such as a Poisson distribution. The resource rates may be increased or decreased by the operators based on triggers received and the peak signals analyzed by the signal processing system 185. The signal processing system 185 recommends the operators regarding the value for modifying the resource rates based on the peak signal analysis.

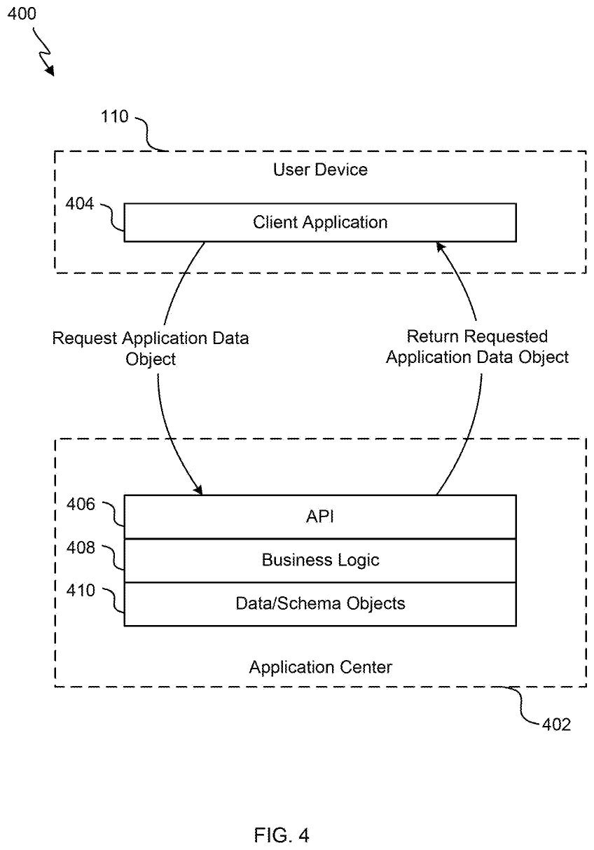

Referring next to FIG. 4, a block diagram of communication 400 of the user device 110 with an application interface is shown as an embodiment. The application interface is embedded with the resource allocation service. The user device 110 and an application center 402 are communicatively coupled with one another. In some embodiments, the user device 110 includes a client application 404 that requests application data objects from the application center 402. The application center 402 includes an Application Program Interface (API) 406, a business logic 408, and data/schema objects 410 for performing various operations on data before transmitting the data back to the client application 404. In some embodiments, the client application 404 is downloaded from the application center 402 and then installed on the user device 110. The client application 404, upon execution on the user device 110, provides various features and options for resource reservation and the resource transaction.

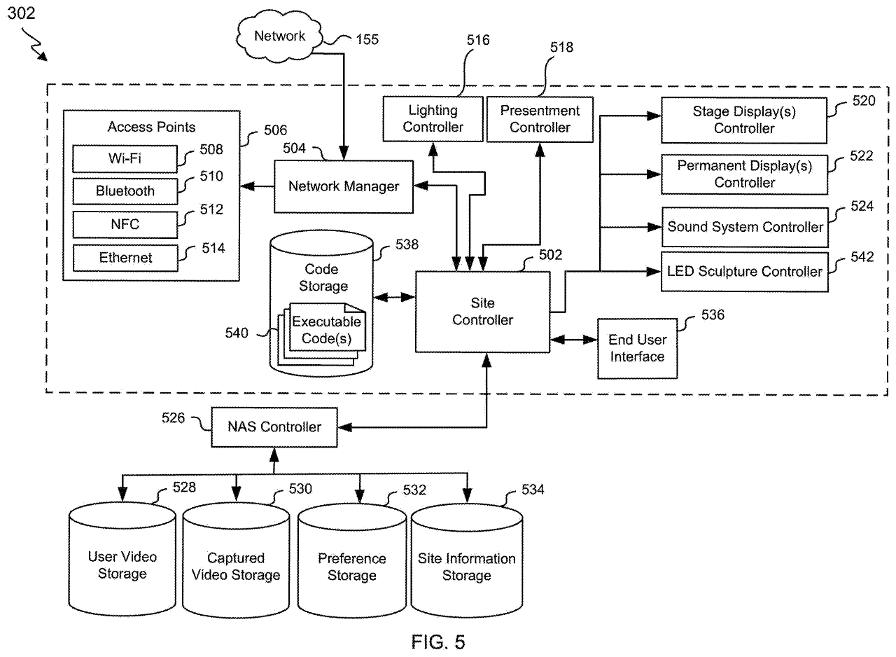

Referring next to FIG. 5, a block diagram of the event location manager 302 is shown as an embodiment. Embodiments of a site controller 502 use a network manager 504 to connect via access points 506 (using e.g., a Wi-Fi 508, Bluetooth 510, a Near Field Technology (NFC) 512, an Ethernet 514, and/or other network connections) to other network components, such as site network and the user device 110. In some embodiments, the site controller 502 adjusts aspects of the event location. Different components of the event location manager 302 adjust a variety of location features, including permanent lights (e.g., with a lighting controller 516), stage lights (e.g., with presentment controller 518), stage display screens (e.g., with stage display(s) controller 520), permanent display screens (e.g., with permanent display(s) controller 522), the location sound system (e.g., with a sound system controller 524), and LED sculpture controller 542.

A Network-Attached Storage (NAS) controller 526 is coupled to a user video storage 528, a captured video storage 530, a preference storage 532, and a site information storage 534. The captured video storage 530 receives, stores, and provides videos received from different user devices. In some embodiments, the site controller 502 triggers an automatic capture of images, audio, and video from user devices 110-1, 110-2, such triggering being synchronized to activities in the event. The images, audio, and video are stored on both the capturing user device and a user video storage 528. In an embodiment, the site controller 502 coordinates the transfer of information from the user devices 110-1, 110-2 to the NAS controller 526 with activities taking place during the event. When interacting with the user devices 110-1, 110-2, some embodiments of the site controller 502 provide an end-user interface 536 to enable different types of interactions. For example, as a part of an engagement activity, the site controller 502 offers contests and other content to the user devices 110-1, 110-2. Additionally, for location determinations, the site controller 502 supplements determined estimates with voluntarily provided information using the end-user interface 536. The event location manager 302 is connected to the network 155.

In some embodiments, the site controller 502 and/or other components of the event location manager 302 use executable codes tangibly stored in a code storage 538 that includes executable code(s) 540 to guide the performance of different activities. In some embodiments, the site information storage 534 provides the information regarding the event location, e.g., resource maps, attendee information, geographic location of destinations (e.g., concessions and exits, etc.), as well as four-dimensional (4D) models of site features and structure.

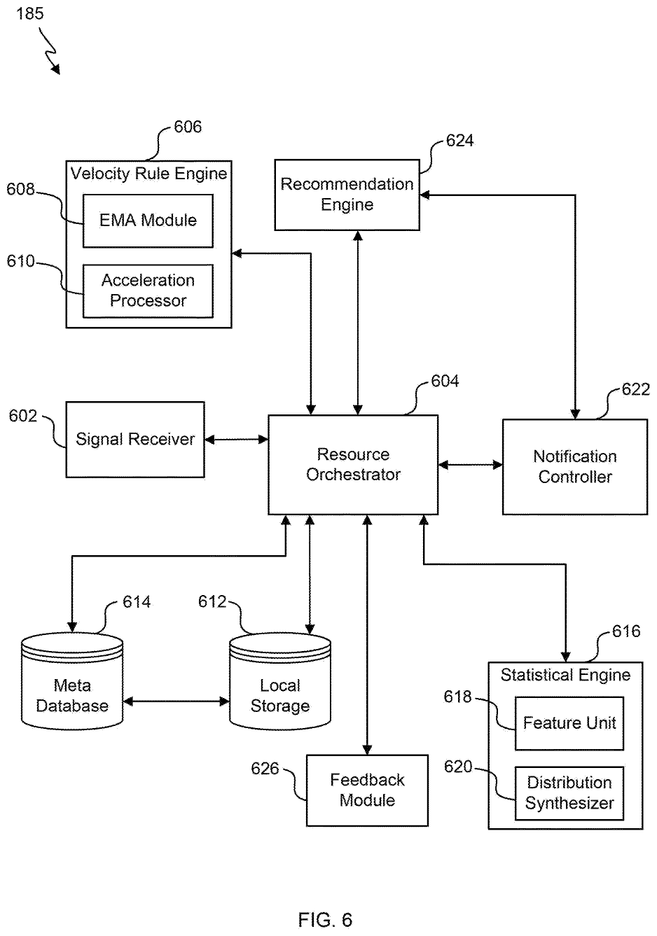

Referring next to FIG. 6, the signal processing system 185 that analyzes different peak signals via a velocity rule engine 606 is shown as an embodiment. The signal processing system 185 analyzes the peak signals related to the event and identifies different triggers related to real-time trends of the resource consumption and resource transfers. In some embodiments, the triggers highlight shift points in the real-time trends of the resource transfer and/or the resource consumption. For example, the triggers indicate whether the peak signal is a result of an abrupt demand in the resources related to the event or an abrupt decrease in demand of the resources. The triggers enable the operators (for example, vendors) to target the event or multiple event segments at opportune instants.

The traditional systems, including established velocity rules, that deliver policies related to resource rate management are substantially configurable, using configurable thresholding to trigger alerts. However, substantial configurations become bottlenecks over time, making it difficult to target what matters most, such as establishing different policies for the resource rates. For the operators, managing different configurations related to substantially configurable velocity rules across the events and setting multiple thresholds for different stages of an event life cycle (for example, presale, on-sale, trough) becomes a time-consuming task. Conventional velocity rules entail multiple configurations for different stages of the event lifecycle, multiple rules for low and high demand situations, and therefore, increase the operational workflow. Moreover, the substantial configurations of the conventional velocity rules generate irrelevant alerts for the operators, creating noise over time.

The signal processing system 185, based on the peak signal analysis, identifies triggers for the operators to target the event segments at the opportune instants, reducing noise and the operational workload for the operators. The signal processing system 185 further generates the alerts based on the resource rates and/or the triggers. The signal processing system 185 includes a signal receiver 602, a resource orchestrator 604, the velocity rule engine 606, a local storage 612, a meta database 614, a statistical engine 616, a recommendation engine 624, a notification controller 622, and a feedback module 626. The velocity rule engine 606 includes an EMA module 608 and an acceleration processor 610. The statistical engine 616 includes a feature unit 618 and a distribution synthesizer 620.

The signal receiver 602 includes API extractors to pull out history and records of the resource reservation, the resource transfer, and/or the resource consumption data and trends from the APIs. The signal receiver 602 uses publicly and privately available data sources to extract the resource consumption data. The resource consumption data and the real-time trends are associated with transferred resources for the event. The signal data and trends further include data regarding reserved resources, browsing data, application (app) data, and/or advertising data. The signal receiver 602 further receives the signal data associated with the event from the resource allocation service. The resource management system 100 executes the resource allocation service that keeps logs of every operation related to the resources. For example, how many resources are allocated, how many resources are reserved, how many resources are unallocated, and maps of the allocation positions. The resource allocation service stores the data in the meta database 614. The signal receiver 602 interprets the signals and extracts the signal data in real-time. The signal receiver 602 extracts the signal data corresponding to a predefined time window and provides the signal data to the resource orchestrator 604.

The resource orchestrator 604 applies mathematical transformations to the signal data to extract valuable information (trends) hidden within the noise, and a level of engagement intensity of different users in the event, such as a fan interest. In an embodiment, different components of the signal processing system 185 utilize the resource orchestrator 604 to perform statistical and signal processing tasks. The resource orchestrator 604 provides the signal data to the velocity rule engine 606 and receives real-time updates on the signal data from the meta database 614. The meta database 614 stores real-time events related to the resources and the users 105-1, 105-2 who perform multiple resource transactions based on disclosed resource rates. In some embodiments, the meta database 614 stores user data that includes username, home address, email address, social media accounts, app history, cart details, transaction history, user preferences, and user attributes. The local storage 612 is in communication with the meta database 614 and receives the real-time updates for local processing.

The velocity rule engine 606 applies multiple algorithms on the signal data received from the resource orchestrator 604. The velocity rule engine 606 requires a single time series signal acquired from the signal data. The transfer functions are fine-tuned to be fast and simple. The velocity rule engine 606 calculates an exponential moving average (EMA) on the signal data. The EMA is a low-pass filter with an infinite impulse response (IIR). The EMA is a weighted average in which recent signal data is given more weight than historical signal data. The EMA reduces noise in an output signal due to the IIR. Furthermore, due to characteristics of the IIR, the EMA remains relevant and does not drop back to zero even when the resource transfer rate remains zero within a time window. The EMA module 608 of the velocity rule engine 606 calculates two distinct types of EMAs from the signal data, a first EMA and a second EMA. The EMA module 608 further compares the first EMA against the second EMA to identify and validate whether a trend reversal is expected.

The velocity rule engine 606 calculates, via the EMA module 608, the first EMA of the signal data over a first time interval and the second EMA of the signal data over a second time interval. The first time interval and the second time interval are different. For example, the second time interval is less than the first time interval, making the second EMA a short EMA (fast) and the first EMA a long EMA (slow). In another embodiment, the first time interval is less than the second time interval, making the first EMA the short EMA and the second EMA the long EMA. To calculate a starting EMA, the EMA module 608 uses:

$${EMA}_{start} = \frac{1}{period} {\sum }_{i = 0}^{period} resource\_transfer {\_count}_{i}$$

To compute a current EMA, the EMA module 608 uses:

$${EMA}_{current} = \frac{resource\_transfer {\_count}_{current} \times 2}{1 + period} + {EMA}_{last} \times ( 1 - \frac{2}{1 + period} )$$

### Whereas:

i: index of value.
period: how many occurrences to use. This value is small for the short EMA and big for the long EMA.
resource_transfer_count: Sum of the count of transferred resources for the recent window.
   By default, 2 is used as a smoothing, but it is possible to change the smoothing to adapt it based on configurations. In an embodiment, the EMA module 608 initializes with a seed from first observation of the signal data. In another embodiment, the EMA module 608 initializes with the seed from a mean of first N samples of the signal data.

After calculating the first EMA and the second EMA, the velocity rule engine 606 calculates a normalized difference between the first EMA and the second EMA. The velocity rule engine 606 subtracts the short EMA from the long EMA and divides the result with the long EMA to normalize a delta.

$$Normlized Difference = \frac{( {EMA}_{short} - {EMA}_{long} )}{{EMA}_{long}}$$

The delta (difference between the first EMA and the second EMA) depends on the event traffic and the traffic context. The velocity rule engine 606 sets a threshold based on the normalized difference. For example, if the delta is 30% or more of the long EMA (the slow EMA), the normalized difference triggers the velocity rule. The threshold based on the normalized difference adapts dynamically to current traffic. The velocity rule engine 606 determines a first weight based on the normalized difference between the first EMA and the second EMA (for example, between the short EMA and the long EMA). The velocity rule engine 606 determines the first weight corresponding to approximately 33% of an aggregated weight.

The velocity rule engine 606 further inputs the signal data to the acceleration processor 610 to calculate a derivative of the signal data and a first approximation of the derivative of the signal data over a sampling period. The first approximation of the derivative of the signal data indicates a velocity of the resource transfers over the sampling period. In an embodiment, the acceleration processor 610 calculates the velocity as a rate of change in the resource transfer count over time, that is a difference in total number of the resources transferred between two distinct points divided by time interval separating the two points. The acceleration processor 610 approximates the derivative with respect to the sampling period to analyze transfer trends. The acceleration processor 610 calculates the velocity based on a central difference technique that provides smooth results for the rate of change of the resource transfer count by factoring in both historical and future signal data relative to a target point. The acceleration processor 610 calculates the velocity based on the central difference technique such as:

$${Velocity}_{i} = \frac{resource\_transfer {\_count}_{( i - 1 )} - resource\_transfer {\_count}_{( i + 1 )}}{2 \times period}$$

### Whereas

i: index of the current value
resource_transfer_count: sum of resource transfers for a window
Period: time window of resource_transfer_count

The conventional velocity rules provide alert configurations to the operators regarding the situations that entail attention from the operators based on velocity alerts. However, relying solely on the velocity does not provide notable insights into the signal data and resource consumption trends. For example, a consistently increasing trend repeatedly triggers alerts even when the operator is already aware of sustained momentum. To detect spikes and presence of the peak signals in the signal data and trends, the velocity rule engine 606 calculates a second approximation of the derivative of the first approximation with respect to the sampling period. The second approximation of the derivative of the first approximation indicates an acceleration.

Based on the acceleration, the acceleration processor 610 identifies when a resource transfer momentum shifts, signaling potential changes in signal data trends. In an embodiment, the signal processing system 185 sets a first threshold for the second approximation to identify, based on the first threshold, different peak signals from an acceleration trend. The second approximation indicates a rate of change in the velocity over time. The acceleration processor 610 layers the first approximation and the second approximation. The velocity rule engine 606 determines a second weight associated with the second approximation or the acceleration. The velocity rule engine 606 determines the second weight corresponding to approximately 33% of the aggregated weight. The velocity rule engine 606 combines the first EMA, the second EMA, and the second approximation to identify the triggers, indicating that the velocity rule is triggered at the opportune instants and only when needed.

The signal processing system 185 includes the statistical engine 616 coupled with the resource orchestrator 604. The resource orchestrator 604 provides the first EMA, the second EMA, the second approximation, the first weight, and the second weight to the statistical engine 616. The statistical engine 616 fine tunes the velocity rule to guarantee that the velocity rule triggers at the opportune instants to take advantage of the resource transfer momentum. Fine tuning the velocity rule via the statistical engine 616 further confirms when to release inventory or raise the resource rates automatically, eliminating the noise from flagged points (such as, identified triggers) in time.

In an embodiment, the feature unit 618 prepares the first EMA, the second EMA, and the second approximation for statistical modeling. The feature unit 618 normalizes and scales the first EMA, the second EMA, and the second approximation to use them as features for statistical processing. The distribution synthesizer 620 generates a graphical distribution from the first EMA, the second EMA, and the second approximation. The distribution synthesizer 620 applies a statistical algorithm to analyze the graphical distribution generated from the first EMA, the second EMA, and the second approximation, and computes a probability of resource transfers within the sampling period. The distribution synthesizer 620 determines a third weight based on the graphical distribution.

In an embodiment, the graphical distribution is a Poisson distribution. As the resource transfers per time window are discrete data samples that indicate a count of the events per time window, the distribution synthesizer 620 generates the Poisson distribution, adapting discrete nature of the signal data. The distribution synthesizer 620 applies the statistical algorithm to analyze the Poisson distribution and computes the probability of the resource transfers by following:

$${probability}_{i} = \frac{{mean}^{resource \_ transfer {\_ count}_{i}} \times {e}^{- mean}}{! resource\_transfer {\_count}_{i}}$$

In an embodiment, the resource orchestrator 604 receives the first weight, the second weight, and the third weight and calculates a coefficient value based on the received weights for the resource rate associated with the resource. The resource orchestrator 604 provides relevant signals to the notification controller 622. By using the notification controller 622, the signal processing system 185 generates the alert based on the triggers and/or the resource rates. The notification controller 622 raises the alerts based on the signals obtained from the resource orchestrator 604. The signal processing system 185 sends the alerts to the primary operators and value engines that manage inventory, the allocation positions, and the resource rates of the resources related to the event. In an embodiment, the signal processing system 185 transmits the alerts on the user devices 110-1, 110-2, and the primary operators via the resource allocation service or the dashboard. The resource orchestrator 604 further provides the triggers identified by the velocity rule engine 606 and the peak signals to the recommendation engine 624.

Based on the triggers, the peak signals, and the resource rates, the recommendation engine 624 calculates different scores for resource rate adjustments. The recommendation engine 624 propagates a score of the recently transferred resource based on a Seat Quality Index (SQI). The score may increase or decrease while adjusting the resource rates. For example, when the peak signal analysis indicates that the resource transfer rate is increasing but the inventory is low, the signal processing system 185 increases the resource rates and alerts the operator to back up the inventory accordingly. Similarly, if the peak signal analysis indicates a dip in the resource transfer rate, the signal processing system 185 decreases the resource rates to fill allocation positions. The operators receive the scores and updated resource rates of the allocation positions based on the SQIs and provide feedback via the feedback module 626.

The feedback includes an approval, a disapproval, or an update of the resource rates. In an embodiment, the signal processing system 185 analyzes the feedback by using an artificial intelligence (AI) module. As the operator may approve, disapprove, or update the resource rates, the AI module executes the feedback to fine-tune the first weight, the second weight, and the third weight. The signal processing system 185 assigns a first value to the first weight, a second value to the second weight, and a third value to the third weight. The AI module ranks the first value, the second value, and the third value based on signal processing algorithms used in their processing, learns an updated coefficient value, and therefore, the resource rates of the resources. When the feedback includes the update, the feedback module 626 delivers the feedback to the resource orchestrator 604 and the recommendation engine 624. The recommendation engine 624 accommodates the modification to the resource rates accordingly.

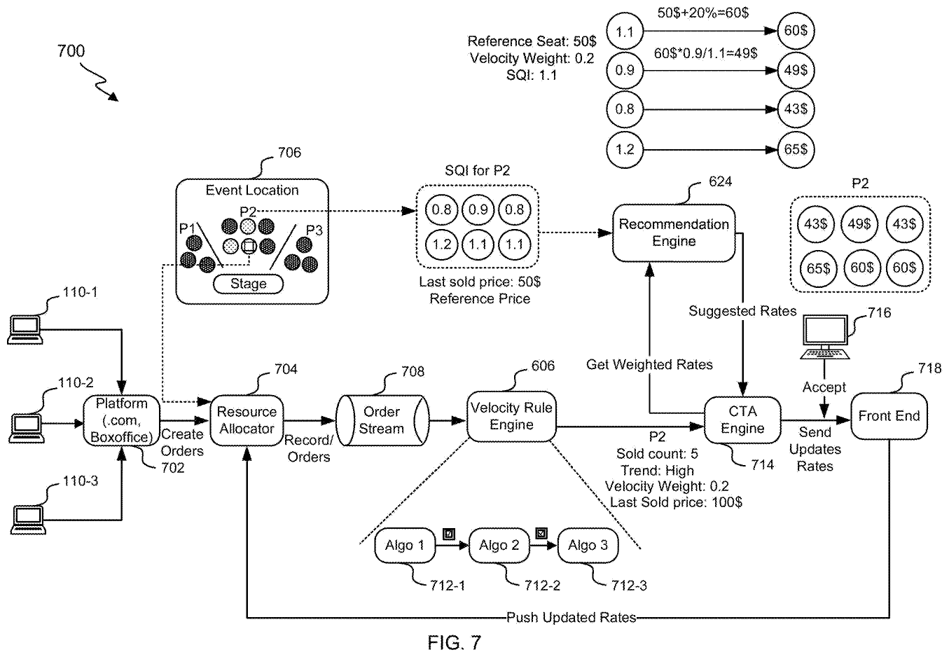

Referring next to FIG. 7, a flow 700 of a signal processing method performing multiple algorithms on the signal data is shown as an embodiment. The flow 700 includes a process of performing multiple algorithms on the signal data to analyze the signal data, detect any signal spikes in the resource demand, and trigger the velocity rule based on the resource transfer trend. The flow 700 further includes calculating and notifying the operators about the updated resource rates based on the SQIs and the resource transfer rate. The user devices 110-1, 110-2, 110-3 request the resources from a platform 702 of the resource management system 100. The platform 702 reserves the resources, based on their availability, for the user devices 110-1, 110-2, 110-3, and creates resource transfer commands for a resource allocator 704. In an exemplary embodiment, the user device 110-3 is a recent requestor of the resource related to the event, while the user device 110-1 is a first requestor of the resource related to the event. The user device 110-3 reserves the resource on the recent resource rate.

The user devices 110-1, 110-2, 110-3 further select the allocation positions from a map of an event location 706. The resource allocator 704 stores the resource transfer commands in an order stream 708. The allocation positions in the event location 706 are segregated into different partitions, such as P1, P2, and/or P3. Every partition includes several allocation positions with associated SQIs. The resource allocator 704 records the resource transfer commands along with selected options from the event location 706 in the order stream 708. The resource allocator 704 further transfers the SQIs of different partitions of the event location 706 to the velocity rule engine 606, which generates and/or modifies the resource rates based on the SQIs, the recent resource rate, and/or the feedback. The resource allocator 704 updates the resource rates based on the signal processing of the signal data.

The velocity rule engine 606 receives the resource transfer commands and related event data from the order stream 708. The velocity rule engine 606 receives the signal data to analyze the peak signals in the trends of the resource transfer rate (a rate of the resource consumption within the time window). The velocity rule engine 606 applies different algorithms on the signal data to generate the resource rates and identify the triggers based on sudden surges of the event traffic, adapting the event traffic and making the threshold dynamic.

In an embodiment, the velocity rule engine 606 applies a first algorithm 712-1 to compute the slow and the fast EMAs of the signal data. The EMA module 608 uses the first algorithm 712-1 to compute the first EMA of the signal data over the first time interval and the second EMA of the signal data over the second time interval. The velocity rule engine 606 applies a second algorithm 712-2 on the signal data to compute the acceleration trend. The second algorithm 712-2 indicates operations of the acceleration processor 610 to calculate the first approximation, the second approximation, and the second weight. The signal processing system 185 sets the first threshold to identify the triggers from the acceleration trend. The velocity rule engine 606 applies a third algorithm 712-3 on the signal data.

The velocity rule engine 606 initiates the statistical engine 616 to perform the third algorithm 712-3 on the signal data. The statistical engine 616, via the third algorithm 712-3, outputs the Poisson distribution and the third weight. The velocity rule engine 606, based on the first algorithm 712-1, the second algorithm 712-2, and the third algorithm 712-3, outputs different statistics related to the partitions of the event location 706. For example, for partition P2, the velocity rule engine 606 outputs 5 as transferred resources, a high trend of resource reservation and the resource transfer, 0.2 as the second weight, and 100$ as the recent resource rate of the resource transferred to the user device 110-3 (the recent requestor).

The velocity rule engine 606 incorporates the SQIs to generate the resource rates. For example, the first algorithm 712-1 assigns the first value as 22/33 to the first weight, the second algorithm 712-2 assigns the second value as 10/33 to the second weight, and the third algorithm 712-3 assigns the third value as 5/33 to the third weight. The signal processing system 185 computes the coefficient value as 37. Based on the resource rate of the resource transferred to the user device 110-3 (the recent requestor), the signal processing system 185 distributes the coefficient value across the allocation positions of the target partition based on the SQIs. For example, for P2, the SQIs for six neighboring allocation positions are defined as 1.1, 1.1, 1.2, 0.8, 0.9, and 0.8, where the recent resource rate of the resource transferred to the user device 110-3 is 50$. For SQI 1.1, the updated resource rate based on the coefficient value is 60$. The signal processing system 185 generates the resource rates as 60$, 65$, 43$, 49$, and 43$ based on the coefficient value and the SQIs.

A contextual threshold analysis (CTA) engine 714 receives the statistics generated via multiple algorithms of the velocity rule engine 606. The CTA engine 714 further receives the first threshold and the second threshold from the signal processing system 185 and works with the recommendation engine 624 to communicate the updates to the user devices 110-1, 110-2, and 110-3. In an embodiment, the CTA engine 714 communicates the resource rates with the primary operators. In another embodiment, the CTA engine 714 communicates the updated resource rates to different user devices after the AI module analyzes the feedback and confirms the resource rates.

Based on the resource transfer requests, the CTA engine 714 requests the recommendation engine 624 about weighted rates for P2. The recommendation engine 624 responds to the request of the CTA engine 714 by transferring the resource rates of the P2. The CTA engine 714 forwards the updated rates to an operator 716. When the operator 716 accepts the updated resource rates and generates the feedback (approved), the CTA engine 714 displays the resource rates on a front end 718 of different user devices. Furthermore, the CTA engine 714 pushes newly generated resource rates based on the traffic context to the resource allocation service. In an embodiment, the CTA engine 714 is the AI module that analyzes the feedback and executes manipulation or modifications using the recommendation engine 624. The AI module weighs the algorithms with their individual rank weights. The rank weights result in a different coefficient value and therefore, a different resource rate for the resource.

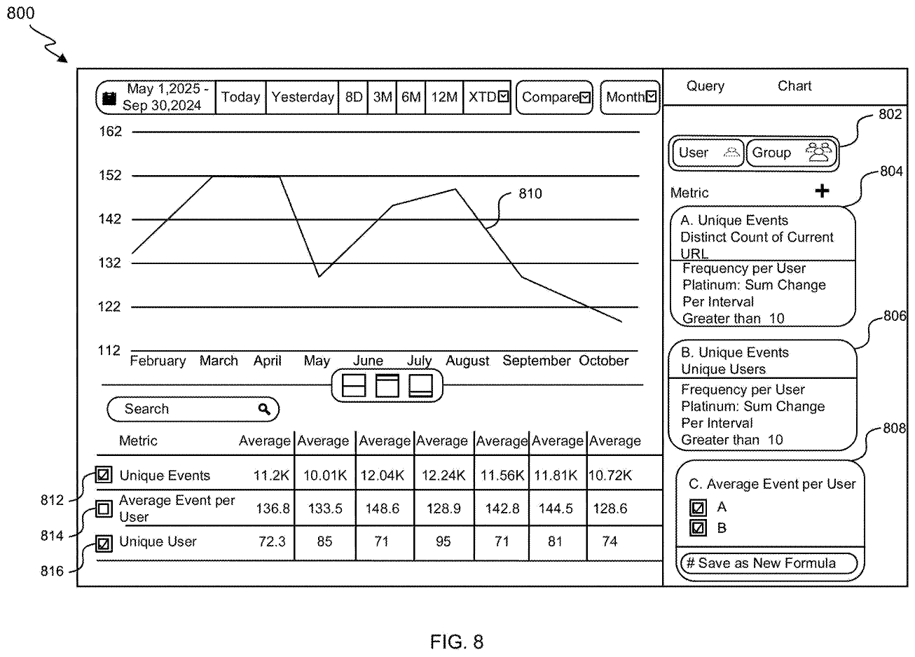

Referring next to FIG. 8, a graphical user interface (GUI) 800 depicting different configurations for event data is shown as an embodiment. The GUI 800 displays exemplary details related to the event. For example, the GUI 800 displays the time window that the operator 716 selects to view the event data. The GUI 800 further includes sections for queries, generating charts, comparing event data against a selected timeline, etc. In section 802, the operator 716 selects details of the operator account, such as a username and a password. Furthermore, the operator 716 can view the event data by selecting a group of users based on their engagement intensities, such as the fan interest. In section 804, a first metric type is shown. The first metric type includes a selection of exclusive events based on frequency per user, status, and a platinum sum change per interval. In section 806, a second metric type is shown. The second metric type includes the selection of the exclusive events based on the users. In section 808, a third metric type is shown. The third metric type indicates the average event per user. The operator 716 observes the average event per user by selecting checkboxes against the exclusive events and/or the users.

In section 810, a graph displaying the average event per user with respect to selected months is shown. Sections 812, 814, and 816 indicate the event data against different metrics, such as the events, average events per user, and the user. The GUI 800 provides various event filters based on the metric selected in sections 812, 814, and 816. The GUI 800 displays the event data that is used to estimate the amount of time the operator 716 allocates to set the thresholds in the conventional velocity rule. For example, based on user-interaction data, the operator 716 consumes a substantial amount of time to set the thresholds for different stages of the event life cycle. To estimate the monthly time required to configure the events via the conventional velocity rules, a formula is modeled as:

$$Total Time = ( ( Events \times \frac{PL}{event} \times lifecycle changes ) \times error rate \times time per rule ) + ( events \times navigation time )$$

Using estimated operational averages as an example, such as 137 for an average event per user, 15 price lists (PL) per event, 3 rule changes for life cycle, 15% manipulation error, 10 seconds for configuring a rule, and 30 seconds navigation time between enterprise data platform (EDP) and dashboard, the total time to manipulate the event is around 20 hours per month. The workload that is added to the workflow of the operator 716 is at least 3 extra days of work per month. In other terms, a team of five primary operators takes around 15 days per month to set the thresholds and rules in established velocity rules system.

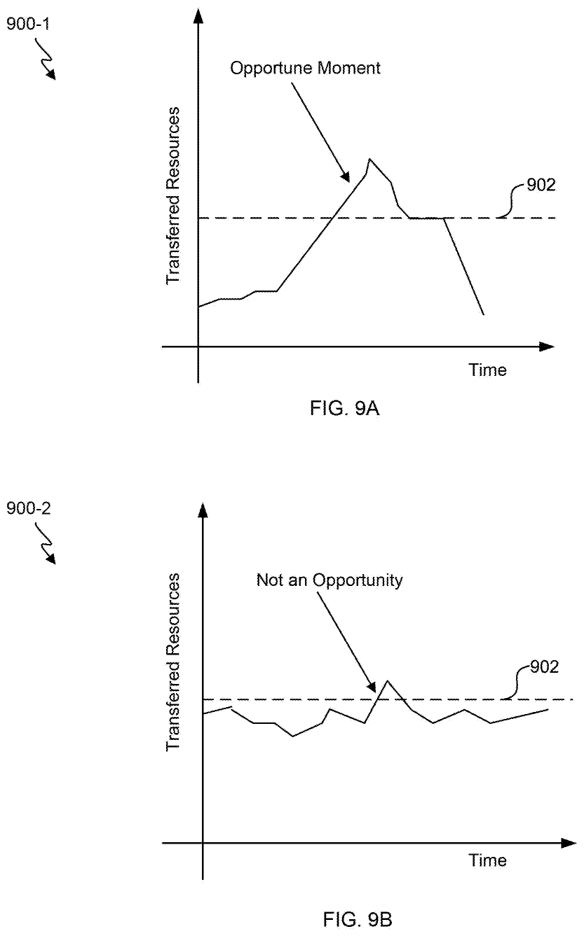

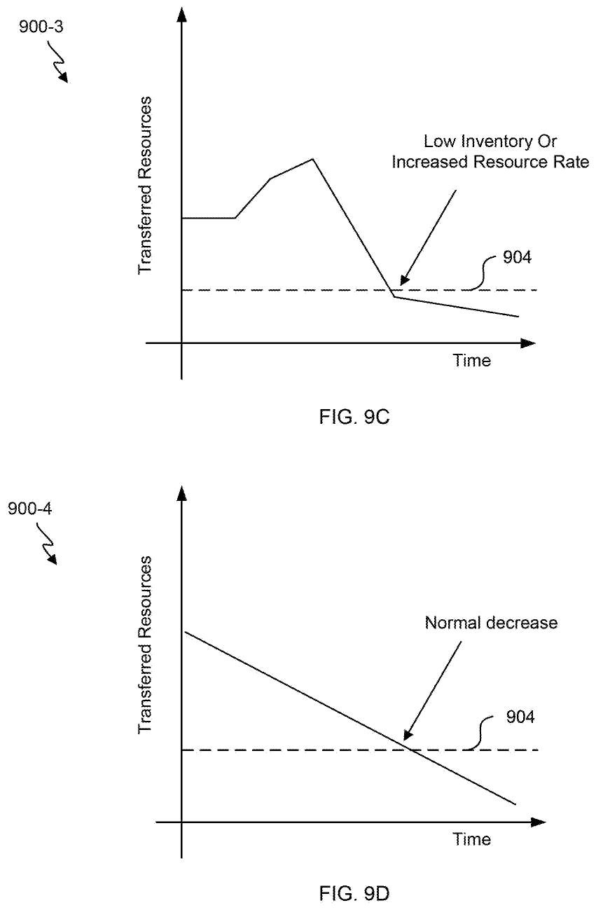

Referring next to FIGS. 9A-9D, different exemplary embodiments of the resource transfer trends are shown. A vertical axis indicates the transferred resources, and a horizontal axis indicates time. A high velocity threshold 902 indicates where the velocity rule triggers. In the conventional velocity rules, the thresholds serve as fixed limits and do not adapt to an event progress. For example, a threshold of 10 resources transferred to different user devices or a single user device in the past hour cannot distinguish between a situation where resource transfer rate increased from low to high and where the resource transfer rate remained consistently high for three hours. FIG. 9A-9B highlight the issue of the established velocity rules where the thresholds do not adapt to the event progress, and the operator 716 is unaware of the sudden spike in event traffic based on the context.

In FIG. 9A, a first exemplary curve 900-1 of the resource transfer rate is shown, which increases gradually during initial intervals. As time progresses, there is a surge in resource demand. The first exemplary curve 900-1 shows an upward deviation that surpasses the high velocity threshold 902 and indicates an opportune instant. Different situations may contribute to the surge of event traffic and the resource demand. For example, a post on a social media platform from a well-known entity announcing attendance at the event. The post may cause a rapid increase in the resource transfer rate, generating a dynamic and short-lived but intense spike in the resource demand. For the established velocity rules, a fixed high velocity threshold does not adapt to the context, and the operator 716 may misinterpret the spike as some violation of technical limitations, or the operator 716 may be unaware of the situation. Furthermore, the resource transfer trend can move downwards as well, indicating situations where either the inventory is low, or the resource demand is decreasing.

In FIG. 9B, a second exemplary curve 900-2 of the resource transfer trend is shown. The second exemplary curve 900-2 indicates the situations where the resource demand fluctuates briefly across the high velocity threshold 902, thus providing a moment that is not a real opportunity, but the established velocity rules still trigger due to the fixed limits of the velocity thresholds. Although there is a sudden surge in the event traffic and the resource demand, a surrounding pattern of the surge lacks structural characteristics of actual resource demand growth. The second exemplary curve 900-2 indicates a false-positive situation where the high velocity threshold 902 is applied without considering temporal patterns. Another use case is when the operator 716 raises the resource rates and plans to know whether raising the resource rates negatively impacts the resource transfer trend. With conventional substantial configurations, the operator 716 entails setting up another set of configurations for low velocity in addition to the high velocity thresholds that have already been set.

FIGS. 9C-9D illustrate different use cases where an abnormal downward trend cannot be differentiated from a normal downward trend, when solely relying on the thresholds. In FIG. 9C, a third exemplary curve 900-3 of the resource transfer trend indicates a downward shift in the resource demand after the resource transfer rate drops below a low velocity threshold 904. The downward shift may happen in two distinct situations: a low inventory and/or increased resource rates, and a normal decrease in the resource demand during a trough period. The fixed limit of the low velocity threshold 904 triggers the velocity rules even when the system functions normally, and the downward shift is expected. This generates false positives for the operator 716 about uninterested situations, creating noise over time, and the velocity rule becoming an overwhelming source of information that is completely irrelevant to the operator 716.

In FIG. 9D, a fourth exemplary curve 900-4 of the resource transfer trend indicates the downwards shift of the resource transfer rate as a result of the trough period, where the event has been highlighted for an extended period. The resource demand reflects a normal lifecycle trend. Due to the fixed limits of the low velocity threshold 904, the operator 716 gets irrelevant alerts which do not provide any actionable sights.

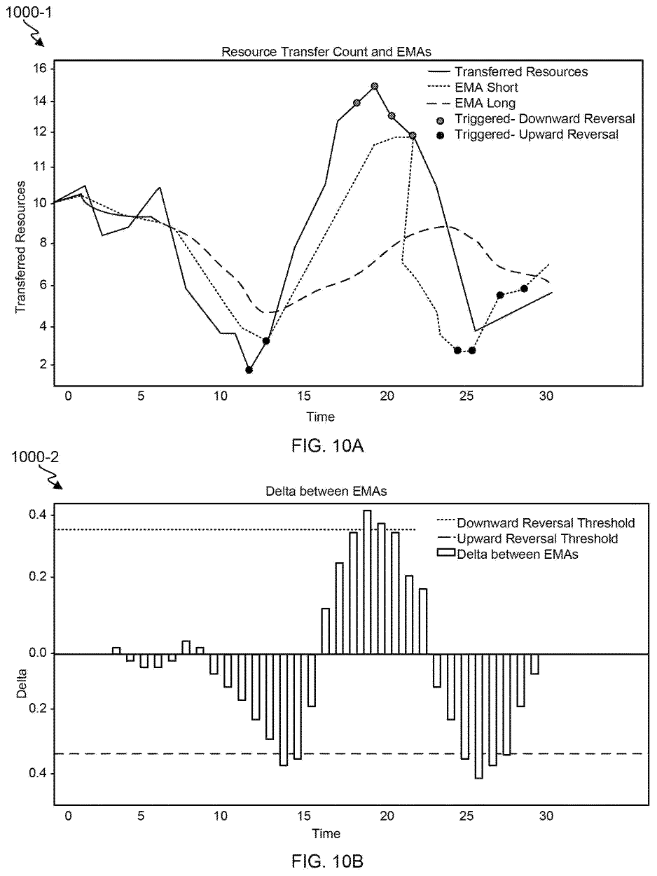

Referring next to FIGS. 10A-10B, exemplary embodiments of the EMAs calculated on the signal data are shown. FIG. 10A shows an EMA graph 1000-1 as an embodiment. The EMA graph 1000-1 depicts the triggers (identified by the signal processing system 185) on downward and upward reversals. Following resource transfer count with 5 minutes as a period is assumed while generating the EMA graph 1000-1. [10.0, 11.0, 9.0, 9.0, 9.0, 10.0, 11.0, 9.0, 7.0, 6.0, 5.0, 4.0, 4.0, 3.0, 8.0, 9.0, 11.0, 15.0, 16.0, 17.0, 15.0, 14.0, 10.0, 9.0, 5.0, 3.0, 2.0, 2.0, 5.0, 6.0, 7.0, 8.0]. The resource transfer count exhibits different downward and upward reversals, including an initial decline around period 7-12 followed by the upward trend between period 14-20.

The short EMA tracks high-frequency variations, for example, variations in the signal data where the resource demand falls or rises rapidly, depending on the event traffic and the traffic context. The long EMA tracks the overall trend during its time interval, reacts slowly to the variations, and remains relatively stable. The EMA graph 1000-1 highlights the triggers when the curve of the resource transfer count shows a notable directional change, upward or downward. For example, near period 12 (the trough period), the short EMA diverges below the long EMA, and a downward reversal is triggered. Around period 14-16, when the short EMA crosses the long EMA and moves substantially upwards, the EMA graph 1000-1 captures an upward reversal trigger that indicates the opportune moments in the resource transfer trend. The short EMA of the signal data provides early signals to the operator 716 about the variations, while the long EMA confirms the variations with reduced noise.

FIG. 10B shows the delta graph 1000-2 between the first EMA and the second EMA, as an embodiment. The delta provides the normalized difference between two EMAs. The delta graph 1000-2 shows a predefined downward reversal threshold and the upward reversal threshold set in the velocity rule. The delta corresponds to the difference between the first EMA and the second EMA, fluctuate above and below zero, and varies depending on whether the short EMA leads or lags the long EMA. The triggered points appear when the delta crosses or maintains near the downward reversal threshold and the upward reversal threshold. For example, during initial periods, the delta fluctuates near zero and reflects a trend of aligned EMAs from the EMA graph 1000-1. Around period 13, the delta increases and marks upward movement in the resource transfer requests. After period 15, the delta stays in a key value for some time and triggers the velocity rule multiple times, even if no reversal happens before the 18th period.

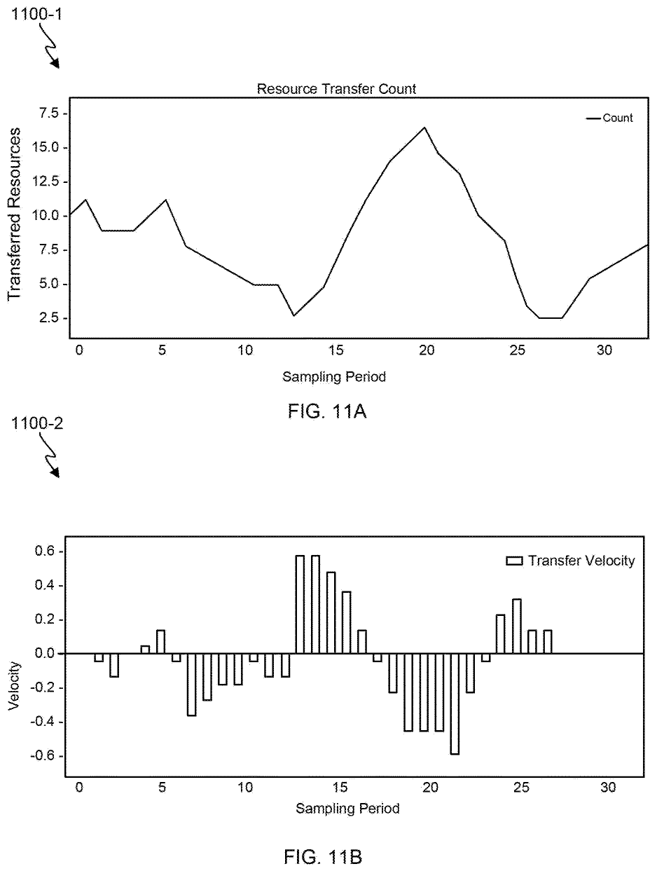

Referring next to FIGS. 11A-11B, exemplary embodiments of the resource transfer count and the first approximation are shown. FIG. 11A shows a count graph 1100-1 of the resource transfer count within a period. The count graph 1100-1 uses the data [10.0, 11.0, 9.0, 9.0, 9.0, 10.0, 11.0, 9.0, 7.0, 6.0, 5.0, 4.0, 4.0, 3.0, 8.0, 9.0, 11.0, 15.0, 16.0, 17.0, 15.0, 14.0, 10.0, 9.0, 5.0, 3.0, 2.0, 2.0, 5.0, 6.0, 7.0, 8.0], incorporating 33 instants in time with every instant representing a window of, for example, every 5 minutes. During initial sampling periods, the resource transfer count fluctuates within a narrow band, indicating almost a consistent resource demand or the trough period. From sampling period 9-20, the resource transfer count progresses, possibly indicating a surge in the resource demand that the operator 716 might be unaware of. From the sampling period 21-30, the count graph 1100-1 shows a sharp dip in the resource transfer count from 15 to 3 units. The count graph 1100-1 represents a substantially non-linear curve of resource transfers, influenced by transients or surges in the resource demand. Such transients may occur due to multiple factors, such as promotional events, inventory effects, or the presence of a notable entity.

FIG. 11B shows a velocity graph 1100-2 of a transfer velocity between adjacent intervals. The velocity graph 1100-2 provides the first approximation of the derivative of the signal data. For the signal data used to generate the count graph 1100-1, the velocity graph 1100-2 results in [0.0, −0.1, −0.2, 0.0, 0.1, 0.2, −0.1, −0.4, −0.3, −0.2, −0.2, −0.1, −0.2, 0.0, 0.7, 0.7, 0.6, 0.5, 0.2, −0.1, −0.3, −0.5, −0.5, −0.5, −0.6, −0.3, −0.1, 0.3, 0.4, 0.2, 0.2, 0.0]. A negative velocity from the sampling period 6-12 and 19-24 indicates a decline in the resource transfer requests or reservations, possibly due to the trough period. A positive velocity from the sampling period 14-18 and 25-30 indicates an increase in the resource transfer requests or reservations. The velocity graph 1100-2 provides insights regarding the situations that entail attention from the operator 716 based on velocity alerts. However, relying solely on the velocity does not provide real-time insights into the signal data and trends.

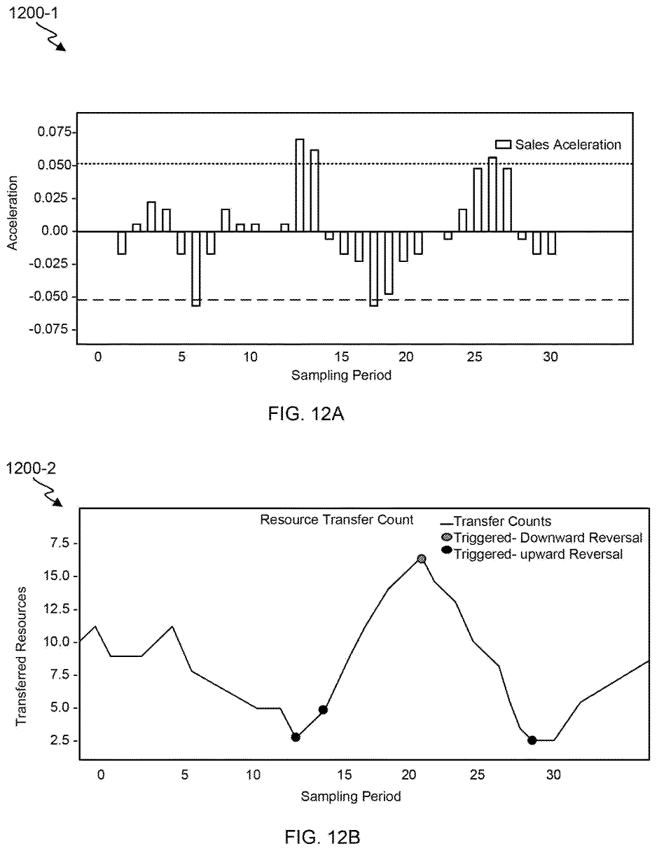

Referring next to FIGS. 12A-12B, exemplary temporal evaluations of the resource transfer count, along with the acceleration trend, are shown. FIG. 12A shows an acceleration graph 1200-1 of the second approximation of the derivative of the first approximation. The first approximation is shown in the velocity graph 1100-2. The acceleration graph 1200-1 further includes an upper threshold and a lower threshold used by the velocity rule. These thresholds indicate dynamic activities related to the resources of the events and the inventory. The upper threshold indicates an early sign of the upward reversal, while the lower threshold indicates the early sign of the downward reversal. In an embodiment, the signal processing system 185 sets the first threshold for the second approximation to identify, based on the first threshold, different peak signals from the acceleration trend (the acceleration graph 1200-1).

FIG. 12B shows a rule graph 1200-2 of the resource transfer count with triggered points identified by the second algorithm 712-2. The rule graph 1200-2 indicates layering the first approximation, the second approximation, and the signal data. The rule graph 1200-2 incorporates the first threshold that the signal processing system 185 uses to identify different triggers from the acceleration trend, offering anticipatory cues about the spikes or dips in the resource consumption. The downward reversal at the sampling period 21 is triggered by the velocity rule when the resource transfer count transitions from an increasing pattern to a decreasing pattern. The upward reversal is triggered at the sampling periods 12, 14, and 30, indicating the surge in demand for the resources related to the event. The rule graph 1200-2 shows that the velocity rule is triggered at the right moment and only when needed, which happens when the first algorithm 712-1 and the second algorithm 712-2 execute in combination.

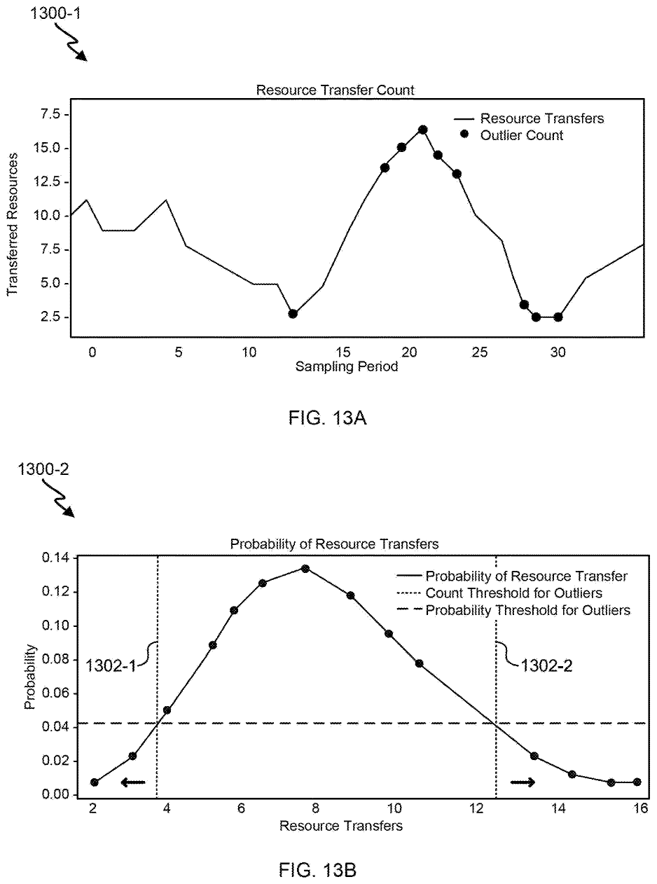

Referring next to FIGS. 13A-13B, statistical techniques to analyze the signal data are shown as exemplary embodiments. The statistical techniques use different mathematical tools to evaluate the signal data and overlay different data samples on one another to provide multiple insights relative to a broader population. When the signal data passes through the first algorithm 712-1 and then the second algorithm 712-2, the signal processing system 185 uses the statistical techniques to fine-tune the velocity rule and reduce the noise from the triggered points. The statistical techniques further highlight outliers in the signal data and the triggered points and confirm whether current triggers are really part of abnormal patterns. FIG. 13A shows an outlier curve 1300-1. The signal processing system 185 executes the third algorithm 712-3 on the signal data and detects the outliers in the acceleration trend.

FIG. 13B shows a probability curve 1300-2 of the signal data. In an embodiment, the signal processing system 185 generates the graphical distribution of the signal data to determine the third weight. The resource transfers are discrete data samples and are more of a count of the events per time window. Furthermore, the resource transfer count often stays at zero during the trough period. Therefore, the signal processing system 185 generates the Poisson distribution of the signal data. The signal processing system 185 computes the probability of the resource transfers. Furthermore, the signal processing system 185 sets a second threshold based on the probability of the resource transfers. The second threshold detects different outliers in the Poisson distribution.

In an embodiment, the signal processing system 185 sets the second threshold of approximately 5% and determines whether the resource transfer count falls outside the Poisson distribution. In some other embodiments, the signal processing system 185 sets the second threshold to approximately 4% to further fine-tune the velocity rule during deployment by analyzing extensive datasets. The probability curve 1300-2 includes the second threshold as a probability threshold for the outliers. A first vertical line 1302-1 and a second vertical line 1302-2 show the resource transfer count where the Poisson distribution crosses the second threshold, representing an upper bound and a lower bound of an outlier region, respectively. For example, the triggered points to the left of the first vertical line 1302-1 and the triggered points to the right of the second vertical line 1302-2 have probabilities below the second threshold and are classified as the outliers.

In an embodiment, the probability curve 1300-2 shows how likely or unlikely the identified triggers or the opportune instants are under suitable operating conditions. For example, the resource transfer counts that are below the probability of 4% and are to the left of the first vertical line 1302-1 are the outliers. Similarly, the resource transfer counts that are below the probability of 4% and are to the right of the second vertical line 1302-2 are also classified as the outliers. Being in the outlier region indicates that the signal processing system 185 is experiencing a resource consumption trend that deviates from a normal resource consumption trend. The outliers indicate conditions that occur infrequently, so the outliers represent the opportune instants for the operator 716. In another embodiment, the signal processing system 185 considers the triggered points as the outliers that are above the second threshold and in between the first vertical line 1302-1 and the second vertical line 1302-2.

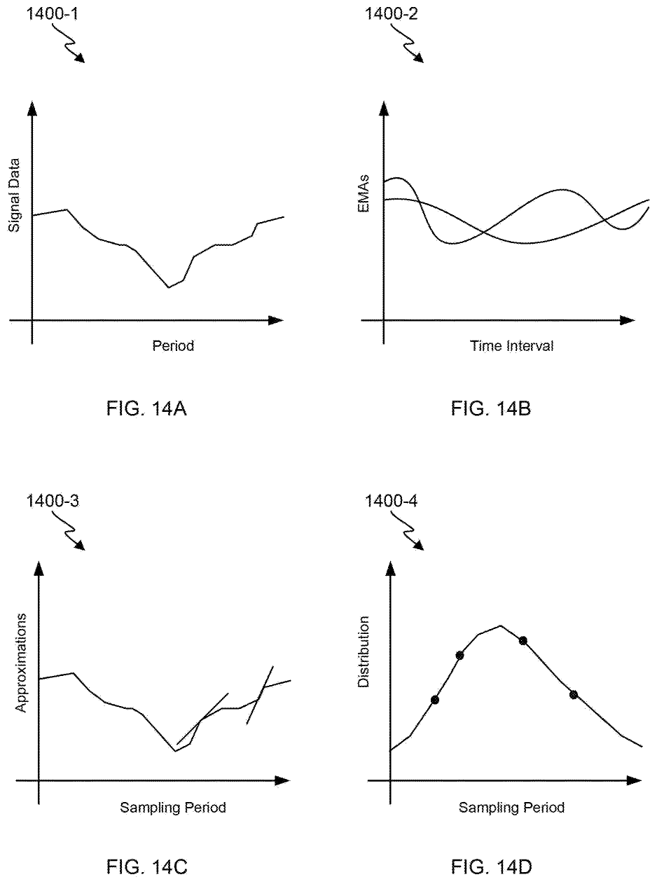

Referring next to FIGS. 14A-14D, exemplary embodiments of statistical processing to analyze peak signals from the signal data are shown. FIG. 14A shows a data curve 1400-1. The data curve 1400-1 includes a pattern of the signal data associated with the resource transfers over a period. FIG. 14B shows a statistical curve 1400-2 of applying statistical operations on the signal data. The statistical curve 1400-2 includes the first EMA and the second EMA calculated on the signal data over the first time interval and the second time interval, respectively. The two EMAs cross one another at a few points. The signal processing system 185 uses the two EMAs to calculate the normalized difference and determines the first weight to identify the triggers.

FIG. 14C shows an approximation curve 1400-3 of derivatives of the signal data. The approximation curve 1400-3 includes the acceleration trend of the signal data that the signal processing system 185 uses to determine the second weight. FIG. 14D shows a distribution curve 1400-4. The distribution curve 1400-4 indicates the Poisson distribution of the signal data to fine-tune the velocity rule and determine the third weight. The signal processing system 185 combines the first weight, the second weight, and the third weight to calculate the coefficient value and manipulate the resource rates of the resources associated with the event based on identified triggers at the opportune instants. The distribution curve 1400-4 shows favorable moments generated after running the first algorithm 712-1, the second algorithm 712-2, and the third algorithm 712-3, and considering the coefficient value along with the SQIs of different allocation positions of the event location 706.

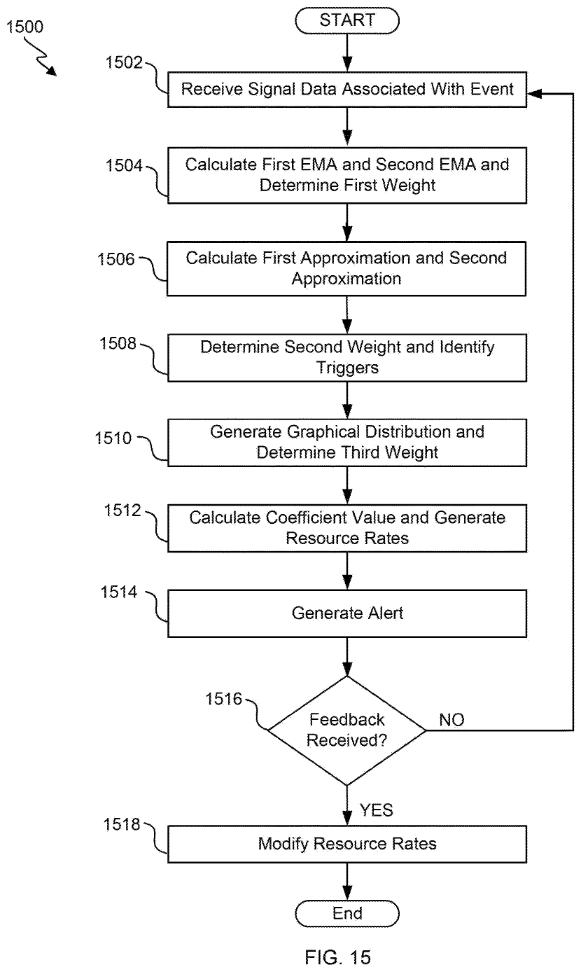

Referring next to FIG. 15, a signal processing method 1500 for analyzing multiple peak signals related to the event is shown as an embodiment. The signal processing method 1500 includes analyzing the signal data and identifying different triggers based on the peak signal analysis. The triggers highlight shift points in the resource transfer/consumption trend. For example, the triggers indicate whether the peak signal is due to an abrupt increase in demand for the resources related to the event, or to an abrupt decrease in demand for those resources. The triggers enable the operator 716 to target different event segments at the right time. The signal processing method 1500 includes setting different thresholds for the velocity rule that adapt dynamically to the event progress. For example, the signal processing method 1500 includes alerting the primary operators when the event inventory decreases.

The signal processing method 1500 includes analyzing demand patterns for the primary operators, in which the primary operators raise resource rates and observe associated impacts on the resource consumption. Furthermore, the signal processing method 1500 includes suppressing noise from the velocity rules and detecting opportunities for the primary operators based on event traffic and traffic context. The signal processing method 1500 includes activating a dynamic approach for the velocity rules. For example, the velocity rule may be available for all the events or may be activated as for different event segments, as needed.

At block 1502, the signal receiver 602 takes the signal data associated with the event. The signal receiver 602 uses the API extractors to extract signal data related to resource demand and resource consumption from private and public data sources and resource allocation services. At block 1504, the velocity rule engine 606 applies the statistical algorithms to calculate the first EMA over the first-time interval and the second EMA over the second time interval. The first- and second-time intervals differ, so the EMAs include the fast and slow EMAs. The EMA is a low-pass filter using the IIR and does not drop back to zero even when the resource transfer rate remains zero within the time window. The signal processing system 185 uses the first algorithm 712-1 to calculate the first and second EMAs. The signal processing system 185 further calculates the normalized difference to determine the first weight.

At block 1506, the acceleration processor 610 calculates the first approximation of the derivative of the signal data over the sampling period. The first approximation indicates the velocity of the resource transfer rate. The acceleration processor 610 further calculates the second approximation of the derivative of the first approximation. The second approximation indicates the acceleration. At block 1508, the velocity rule engine 606 determines the second weight associated with the acceleration of the signal data. The velocity rule engine 606 further identifies the triggers from the acceleration trend. The velocity rule engine 606 sets the first threshold for the second approximation to identify, from that threshold, different triggers in the acceleration trend. The triggers indicate instants in a timeline of the event, particularly during the trough period, at which the primary operators can regulate the resource rates of different allocation positions. The triggers and thresholds dynamically adapt real-time patterns observed in underlying data.

At block 1510, the signal processing system 185 generates the graphical distribution and applies the third algorithm 712-3 to analyze the graphical distribution generated from the first EMA, the second EMA, and the second approximation. The graphical distribution is the Poisson distribution due to the discrete data samples. The signal processing system 185 further determines the third weight based on the Poisson distribution. The Poisson distribution shows the peak signals/triggers that indicate key events in resource transfer data, which need attention from the primary operators. For example, fluctuations in resource demand, consumption, and supply.

At block 1512, the signal processing system 185 calculates the coefficient value and generates the resource rates. The signal processing system 185 calculates the coefficient value for the resource rate associated with the event from the first, second, and third weights. The signal processing system 185 further calculates the coefficient value based on the recent resource rate of the resource associated with the event. The signal processing system 185 generates the resource rates for the resources based on the SQIs of different allocation positions present in the event location 706. At block 1514, the signal processing system 185 generates alerts based on the resource rates and the triggers. The signal processing system 185 recommends the resource rates to the operator 716.

At block 1516, the signal processing system 185 monitors whether the operator 716 has provided the feedback. The feedback includes the approval, disapproval, or updates to the resource rates. The operator 716 may accept the updated resource rates based on the SQIs or reject them based on other factors of the velocity rule. In an embodiment, the operator 716 may provide feedback regarding the update of the resource rates based on the triggers and observed patterns. If the signal processing system 185 receives the feedback, the signal processing system modifies the resource rates at block 1518. Otherwise, the signal processing system 185 keeps receiving the signal data at block 1502.

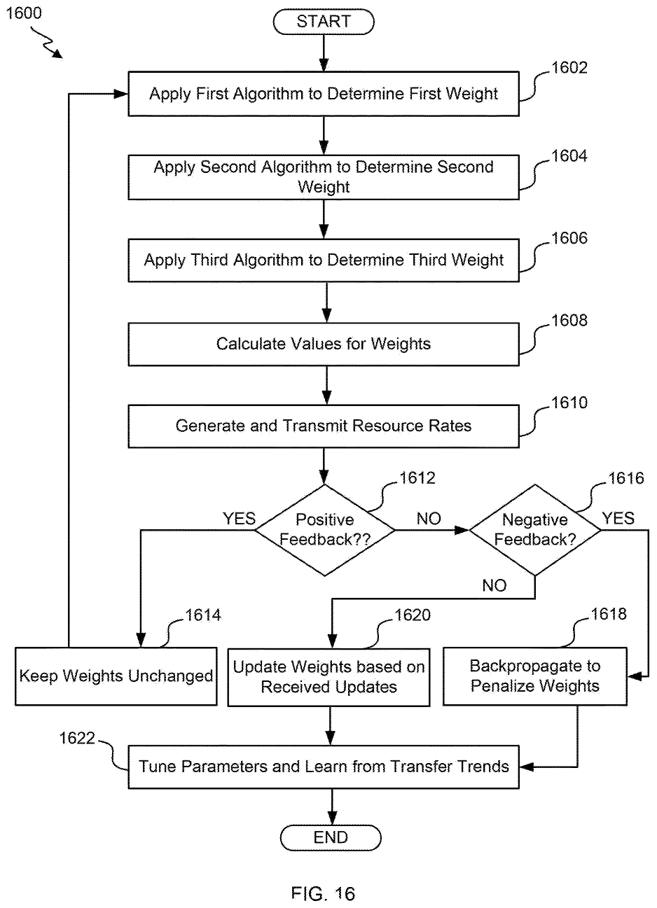

Referring next to FIG. 16, a flowchart 1600 of training the AI module based on the weights is shown as an embodiment. The signal processing system 185 trains the AI module using triggers and feedback from different users and/or operators. The velocity rule engine 606 uses various signal processing and statistical algorithms to compute the weights. The signal processing system 185 uses the weights to update the resource rates and to recommend the updates to the vendors, operators, and/or the users.

At block 1602, the velocity rule engine 606 applies the first algorithm 712-1 on the signal data to determine the first weight. The first weight is associated with the normalized difference between the first EMA and the second EMA. At block 1604, the velocity rule engine 606 applies the second algorithm 712-2 on the signal data to determine the second weight. The second weight is associated with the second approximation of the derivative of the first approximation. At block 1606, the signal processing system 185 applies the third algorithm 712-3 and determines the third weight. The third weight is associated with the Poisson distribution. In an embodiment, the signal processing system 185 applies multiple algorithms and determines multiple weights related to predefined features of each algorithm. For example, the signal processing system 185 applies n algorithms to compute n weights. The signal processing system 185 uses the weights and sets different thresholds to identify the triggers and the outliers.

At block 1608, the signal processing system 185 calculates the first value for the first weight, the second value for the second weight, and the third value for the third weight. In an embodiment, values indicate the importance of respective weights. At block 1610, the signal processing system 185 calculates the coefficient value from the identified triggers and generates the resource rates according to the SQIs of the event location 706. The signal processing system 185 transmits the resource rates to the operators.

At block 1612, the feedback module 626 detects the type of feedback received on the resource rates. For positive feedback (the approval), the signal processing system 185 keeps the weights unchanged, and the AI module preserves learned behavior at block 1614. At block 1616, the signal processing system 185 detects whether the feedback is negative (disapproval). If so, the AI module backpropagates and penalizes its parameters at block 1618. The AI module computes a loss on the total objective with respect to the parameters, penalizing the parameters via weight decay (L2) or sparsity (L1) regularizer. The AI module adjusts the parameters to fit the signal data as well as received feedback.

At block 1620, in case of neither the positive nor the negative feedback, the signal processing system 185 detects the updates in the resource rates as the feedback, where the operator 716 updates the recommended resource rates based on market patterns, the triggers, and/or the transfer trends. At block 1622, the AI module tunes the parameters and learns from the resource transfer trends. The signal processing system 185 analyzes the peak signals related to the event, factors in favorable instants to update the resource rates, and recommends the resource rates to the operator 716 based on the triggers. The signal processing system 185 extracts information on levels of fan interests in the events and provides adaptive velocity rules where alerts and/or actions are activated at the right time without requiring manual adjustments, devoid of trial-and-error by the operators.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMS, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A signal processing method for analyzing a plurality of peak signals related to an event, the signal processing method comprising:
receiving a signal data associated with the event from a resource allocation service;
calculating, via a velocity rule engine, a first exponential moving average (EMA) of the signal data over a first time interval and a second EMA of the signal data over a second time interval, wherein the velocity rule engine is operable to:
determine a first weight based on a normalized difference between the first EMA and the second EMA,
calculate a first approximation of a derivative of the signal data over a sampling period,
calculate a second approximation of the derivative of the first approximation with respect to the sampling period,
determine a second weight associated with the second approximation, and
combine the first EMA, the second EMA, and the second approximation to identify a plurality of triggers;
applying a statistical algorithm to analyze a graphical distribution generated from the first EMA, the second EMA, and the second approximation, and determining a third weight based on the graphical distribution;
calculating a coefficient value based on the first weight, the second weight, and the third weight, and generating a plurality of resource rates based on the coefficient value;
generating an alert based on one or more of the plurality of resource rates and the plurality of triggers; and
modifying the plurality of resource rates based on feedback on the plurality of resource rates.

2. The signal processing method for analyzing the plurality of peak signals related to the event of claim 1, further comprising analyzing the feedback using an artificial intelligence (AI) module, wherein the feedback comprises one or more of an approval, a disapproval, and an update of the plurality of resource rates.

3. The signal processing method for analyzing the plurality of peak signals related to the event of claim 1, wherein the generation of the plurality of resource rates comprises generating the plurality of resource rates for a plurality of resources based on a recent resource rate of a resource associated with the event and a plurality of seat quality indices (SQIs) of an event location.

4. The signal processing method of claim 1, wherein the first approximation of the derivative of the signal data indicates a velocity and the second approximation of the derivative of the first approximation indicates an acceleration, and wherein the velocity rule engine is further operable to calculate the velocity based on a central difference of the signal data over twice of the sampling period.

5. The signal processing method of claim 1, further comprising setting a first threshold for the second approximation to identify, based on the first threshold, the plurality of triggers from an acceleration trend.

6. The signal processing method of claim 1, further comprising computing a probability of resource transfers, and setting a second threshold based on the probability of the resource transfers, wherein the second threshold detects a plurality of outliers in the graphical distribution.

7. The signal processing method of claim 1, further comprising calculating a first value for the first weight, a second value for the second weight, and a third value for the third weight.

8. The signal processing method of claim 1, wherein the graphical distribution is a Poisson distribution.

9. A signal processing system to analyze a plurality of peak signals related to an event, the signal processing system operable to:
receive a signal data associated with the event from a resource allocation service;
calculate, via a velocity rule engine, a first exponential moving average (EMA) of the signal data over a first time interval and a second EMA of the signal data over a second time interval, wherein the velocity rule engine is operable to:
determine a first weight based on a normalized difference between the first EMA and the second EMA,
calculate a first approximation of a derivative of the signal data over a sampling period and a second approximation of the derivative of the first approximation with respect to the sampling period,
determine a second weight associated with the second approximation, and
combine the first EMA, the second EMA, and the second approximation to identify a plurality of triggers;
apply a statistical algorithm to analyze a graphical distribution generated from the first EMA, the second EMA, and the second approximation, and determine a third weight based on the graphical distribution;
calculate a coefficient value based on the first weight, the second weight, and the third weight, and generate a plurality of resource rates based on the coefficient value;
generate an alert based on one or more of the plurality of resource rates and the plurality of triggers; and
modify the plurality of resource rates based on feedback on the plurality of resource rates.

10. The signal processing system to analyze the plurality of peak signals related to the event of claim 9, is further operable to analyze the feedback using an artificial intelligence (AI) module, wherein the feedback comprises one or more of an approval, a disapproval, and an update of the plurality of resource rates.

11. The signal processing system to analyze the plurality of peak signals related to the event of claim 9, wherein the graphical distribution is a Poisson distribution.

12. The signal processing system to analyze the plurality of peak signals related to the event of claim 9, wherein the first approximation of the derivative of the signal data indicates a velocity and the second approximation of the derivative of the first approximation indicates an acceleration, and wherein the velocity rule engine is further operable to calculate the velocity based on a central difference of the signal data over twice of the sampling period.

13. The signal processing system to analyze the plurality of peak signals related to the event of claim 9, is further operable to set a first threshold for the second approximation to identify, based on the first threshold, the plurality of triggers from an acceleration trend.

14. The signal processing system to analyze the plurality of peak signals related to the event of claim 9, is further operable to compute a probability of resource transfers and set a second threshold based on the probability of the resource transfers, wherein the second threshold detects a plurality of outliers in the graphical distribution.

15. A computer-readable medium having computer-executable instructions embodied thereon that, when executed by one or more processors, facilitates a signal processing method for analyzing a plurality of peak signals related to an event, the signal processing method comprising:
receiving a signal data associated with the event from a resource allocation service;
calculating, via a velocity rule engine, a first exponential moving average (EMA) of the signal data over a first time interval and a second EMA of the signal data over a second time interval, wherein the first time interval is different from the second time interval, and wherein the velocity rule engine is operable to:
determine a first weight based on a normalized difference between the first EMA and the second EMA,
calculate a first approximation of a derivative of the signal data over a sampling period and a second approximation of the derivative of the first approximation with respect to the sampling period,
determine a second weight associated with the second approximation, and
combine the first EMA, the second EMA, and the second approximation to identify a plurality of triggers;
applying a statistical algorithm to analyze a graphical distribution generated from the first EMA, the second EMA, and the second approximation;
determining a third weight based on the graphical distribution;
calculating a coefficient value based on the first weight, the second weight, and the third weight, and generating a plurality of resource rates based on the coefficient value;
generating an alert based on one or more of the plurality of resource rates and the plurality of triggers; and
modifying the plurality of resource rates based on feedback on the plurality of resource rates.

16. The computer-readable medium having the computer-executable instructions embodied thereon that, when executed by the one or more processors, facilitates the signal processing method for analyzing the plurality of peak signals related to the event of claim 15, wherein the generation of the plurality of resource rates comprises generating the plurality of resource rates for a plurality of resources based on a recent resource rate of a resource associated with the event and a plurality of seat quality indices (SQIs) of an event location.

17. The computer-readable medium having the computer-executable instructions embodied thereon that, when executed by the one or more processors, facilitates the signal processing method for analyzing the plurality of peak signals related to the event of claim 15, wherein the signal processing method further comprises analyzing the feedback using an artificial intelligence (AI) module, wherein the feedback comprises one or more of an approval, a disapproval, and an update of the plurality of resource rates.

18. The computer-readable medium having the computer-executable instructions embodied thereon that, when executed by the one or more processors, facilitates the signal processing method for analyzing the plurality of peak signals related to the event of claim 15, wherein the signal processing method further comprises setting a first threshold for the second approximation to identify, based on the first threshold, the plurality of peak signals from an acceleration trend.

19. The computer-readable medium having the computer-executable instructions embodied thereon that, when executed by the one or more processors, facilitates the signal processing method for analyzing the plurality of peak signals related to the event of claim 15, wherein the signal processing method further comprises computing a probability of resource transfers and setting a second threshold based on the probability of the resource transfers, wherein the second threshold detects a plurality of outliers in the graphical distribution, and wherein the graphical distribution is a Poisson distribution.

20. The computer-readable medium having the computer-executable instructions embodied thereon that, when executed by the one or more processors, facilitates the signal processing method for analyzing the plurality of peak signals related to the event of claim 15, wherein the first approximation of the derivative of the signal data indicates a velocity and the second approximation of the derivative of the first approximation indicates an acceleration, and wherein the velocity rule engine is further operable to calculate the velocity based on a central difference of the signal data over twice of the sampling period.
